(19) United States
(12) Patent Application Publication
(10) Pub. No.: US 2008/0109289 A1
(43) Pub. Date: May 8, 2008

(54) System and method for systematic management and measurement of workplace real estate and the use of real estate by people

(75) Inventors: John H. Vivadelli, Richmond, VA (US); Brian B. Coller, Midlothian, VA (US); Lyall W. Shank, Beaverdam, VA (US)

Correspondence Address: WILLIAMS MULLEN, 222 CENTRAL PARK AVENUE, SUITE 1700, VIRGINIA BEACH, VA, 23462, US

(73) Assignee: Agilquest Corporation

(21) Appl. No.: 11/978,439

(22) Filed: Oct. 29, 2007

Related U.S. Application Data
(63) Continuation-in-part of application No. 10/489,160, filed on Mar. 8, 2004, now Pat. No. 7,289,619.
(60) Provisional application No. 60/346,880, filed on Jan. 9, 2002.
(60) Provisional application No. 60/346,950, filed on Jan. 9, 2002.
(60) Provisional application No. 60/858,223, filed on Nov. 9, 2006.

(51) Int. Cl. G06Q 10/00

(52) U.S. Cl. 705/7

(57) ABSTRACT

The present invention provides a system and method for measuring the actual use of real estate space, overall and by individual, in a variety of corporate real estate environments in order to facilitate the maximization of return on real estate and resource investments, optimize the efficiency of workspaces, automate the reservation and scheduling of workspaces, equipment and services, optimize tele-work and mobile work strategies, and report on space utilization and plan for future needs. The present invention integrates a workplace management component, a sensor system and an actual use of space analysis engine to provide significantly enhanced data accuracy regarding use of space, which improves system effectiveness and affects individual behavior. By affecting individual behavior, the system produces even greater data accuracy and improved control and management of resources.

### CROSS-REFERENCE TO RELATED APPLICATIONS

This application claims the benefit of U.S. provisional application Ser. No. 60/858,223, filed Nov. 9, 2006 and entitled “System and Method for Managing Workplace Real Estate Using Sensors.” This application further claims the benefit of U.S. utility patent application Ser. No. 10/489,160, filed Mar. 8, 2004 and entitled “System and Method for Managing Workplace Real Estate and Other Resources,” which claims the benefit of U.S. provisional application Ser. Nos. 60/346,880 entitled “Mobile Officing Reservation System and Method” and 60/346,950, entitled “Communications Interface for Mobile Officing Reservation System”, both filed Jan. 9, 2002, and both of common assignee herewith. The specifications of all of the above are incorporated herein by reference.

### TECHNICAL FIELD

The present invention relates to computer-assisted management of business real estate and the amount of real estate used by people, and more particularly to a comprehensive method and system for managing and measuring workplace real estate and resources and the use of workplaces by people using sensors so as to assist businesses in maximizing utilization and productivity.

### BACKGROUND ART

Modern corporations require many types of assets in order to function profitably. Depending on the business the corporation is in, the company may need raw materials, storage facilities, equipment, commercial real estate, information processing capabilities, communications systems and, of course, personnel. Since many assets or resources are not used at all times, they may be available for multiple users or for individual users for specific periods of time. It is important for companies to control the management of such shared resources in order to ensure proper utilization and justify continuing investment in the resources. This is especially so given increasing worker mobility and business real estate costs (particularly unused real estate). By ensuring that employees get the resources they need, wherever they are, and that real estate is used efficiently, companies can reduce costs, and increase productivity and profitability.

The earliest mobile officing solutions were completely full-service initiatives run by concierges who managed reservations and set up workspaces for daily use. More recently, systems for managing and distributing resources among employees have relied upon paper-based spreadsheets, log books or e-mail calendaring. These approaches fall short in several areas, not the least of which is their inability to manage resources across the enterprise or have accurate knowledge of actual real estate space usage in order to make better resource decisions. Current allocation or scheduling systems only provide data about workspaces that were requested or assigned.

Regarding actual use of space, the traditional process for measuring space utilization is to perform a manual walk through of the space and record human presence, or “signs of life” (e.g., a jacket on a chair). This process is often referred to as bed checking. Bed checks are thought to be inexpensive and relatively accurate. In fact, they are neither. Bed checks are labor intensive, not only for the collection of the data by having people walk around the facilities (a very time consuming and nearly impossible task in a large facility), but also for the people who take the huge amount of data collected and manually enter or consolidate it in a computer system. This might be feasible for a one-time measurement, but to sustain this effort on an ongoing basis is unrealistic

Bed checks are inaccurate because they need to take place at a specific moment in time for the entire facility. If the room occupant steps away from his or her workspace, or is attending a meeting, the workspace can be mis-classified as unused. The same problem arises when a person works offsite in the morning and comes into the office in the afternoon. It's very easy to “see” when a workspace is utilized, but it is nearly impossible to “see” when it is not being used that day. In addition, these bed checks do not measure who used the space and for how long, bed checks only measure the use of the workspace for the instant it is observed.

Such inaccuracies and inefficiencies create major problems for executives who need to know where, when, and how users actually interact with the work environment so they can provide their fellow employees with a highly effective workplace tuned to the changing needs of the organization. Space planning is an ongoing process, and organizations continually need to adjust their workspace to meet changing market and economic conditions. By knowing the use of each workspace, and the amount of space each person uses, management can calculate for any particular group of people the type and quantity of space needed to support that work. The advent of the mobile workforce is the catalyst which allows many, if not most, employees to effectively “work from anywhere” making their workspace a static, underutilized liability for the organization. Studies by the International Facilities Management Association show that the cost of providing a workspace to an employee ranges between $8,000 and $14,000 per year. If the average utilization for each space is 50%, then the company is wasting $4,000 to $7,000 per year for each underutilized workspace.

In addition, this unused real estate continues to consume energy and emit greenhouse gases, significantly impacting our country's ability to build and operate sustainable workplaces. In the US today, commercial office space represents 18% of our energy consumption. Finding ways to eliminate wasted space, or slowing the growth of new construction, provides substantial long term sustainability benefits. Though the use of the present invention, actual use of space event can be used to control various building systems (lighting, HVAC, etc.) and turn off these systems when not needed by the occupant.

Divesting underutilized real estate is a major business issue that can be addressed by accurately measuring how space is actually used. For example, when leases come due, organizations need to understand how they actually use space to determine if they should renew the lease, move, or consolidate. In many facilities, there is a “feeling” that there are too many unused workspaces during the work day, even though all workspaces are allocated to a department or to individuals. Many studies show that the utilization of the average workplace is less than 50%. One of the problems is that the unused workspace changes from day to day.

Another major business issue that can be addressed by accurate knowledge of actual use, and the amount of space each person uses, is how to add more employees without adding to facilities. The problem arises when there is a need to add people to a location that cannot physically house them, such as when organizations grow or when facilities are consolidated. Oftentimes, the need to add people to a location occurs when there is no budget for additional facilities.

The US Government and many states have teleworking initiatives designed to move work to people rather than people to work, thus decreasing the demand on roadways, reducing the time wasted and the carbon footprint of daily commuting, improving work/life balance, and many other benefits. However, there exists now good way to measure the number of commutes avoided by telework. By knowing the acutal use of space

Most facility and real estate managers maintain an inventory of workspaces. These lists (spreadsheets, architect drawings, computer-aided facilities management (CAFM) systems, etc.) are useful to track how many workspaces are in a building, the size (square footage) of each workspace, and how each workspace is allocated (by department or individual). However, these lists do not measure actual use of space. For example, the following sample tabe (Table 1) shows the inventory of workspaces, the size of each workspace, the allocation, and the cost of the workspace for a given employer using an industry standard or corporate-determined cost per square foot.

TABLE 1

| Room ID | Department | Occupant | Room Area | Room Cost |
|---|---|---|---|---|
| 104 | Marketing | J. Jones | 184 | $13,143 |
| 103 | Marketing | R. Bowen | 176 | $12,571 |
| 110 | Finance | T. Tucker | 132 | $9,429 |
| 101 | Marketing | W. Jones | 154 | $11,000 |
| 105 | Marketing | D. Dollars | 145 | $10,357 |
| 108 | Finance | P. Peartree | 127 | 9,071 |
| 102 | Marketing | S. Smith | 122 | $8,714 |
| 107 | Finance | F. Beagle | 137 | $9,786 |
| 109 | Finance | M. Money | 143 | $10,214 |
| 106 | Finance | E. Apples | 110 | $7,857 |
| | | Total | 1430 | $102,143 |
| | | Average | 143 | $10,214 |

Table 2, on the other hand, shows the additional “actual use” factors, both by and by person, which provides an invaluable tool for real estate management.

TABLE 2

| | | | Room | | | Cost of |
|---|---|---|---|---|---|---|
| Room ID | Department | Occupant | Area | Room Cost | Utilization | Underutilization |
| 104 | Marketing | J. Jones | 184 | $13,143 | 10% | $11,829 |
| 103 | Marketing | R. Bowen | 176 | $12,571 | 23% | $9,680 |
| 110 | Finance | T. Tucker | 132 | $9,429 | 14% | $8,109 |
| 101 | Marketing | W. Jones | 154 | $11,000 | 37% | $6,930 |
| 105 | Marketing | D. Dollars | 145 | $10,357 | 34% | $6,836 |
| 108 | Finance | P. Peartree | 127 | 9,071 | 43% | $5,171 |
| 102 | Marketing | S. Smith | 122 | $8,714 | 43% | $4,967 |
| 107 | Finance | F. Beagle | 137 | $9,786 | 54% | $4,501 |
| 109 | Finance | M. Money | 143 | $10,214 | 67% | $3,371 |
| 106 | Finance | E. Apples | 110 | $7,857 | 72% | $2,200 |
| | | Total | 1430 | $102,143 | | $63,589 |
| | | Average | 143 | $10,214 | 38% | |

The Table 2 report shows how much the company spends for facilities and how much money is wasted by the “under-utilization” of each space. By sorting this report by “Cost of Underutilization,” for example, the most underutilized workspaces and the most mobile workers can be identified. Importantly, if the actual use information is not accurate, the costs and measurements are meaningless.

### SUMMARY OF THE INVENTION

By the present invention, organizations can proactively manage all types of workplace real estate as well as measure the actual use of workplace real estate and the use of space by each person across departments and other organizational entities or groupings, and across floors, types of space, facilities, and geographical regions Workplace management tools can be used to manipulate resources in real-time, automate inefficient processes, and track and analyze usage patterns, in order to make wise short- and long-term space and resource decisions.

A workspace management component (WMC) provided as part of the present invention allows businesses to improve inefficient resource distribution methods while providing a facility and/or enterprise-wide view of all its real estate assets, including permanently assigned, collaboration and shared. Users of the WMC benefit from automated, easy-to-use services—deployed at either a single facility or across an enterprise—that can be accessed through a common interface, regardless of location. The WMC includes a resource management tool for creating, storing and accessing information about resources, such as real estate, computers, catering services and the like. The WMC also includes a user management tool for creating, storing and accessing information about users, such as user-defined roles, resource manipulation privileges, profile information and the like. The WMC further includes a transaction management component to allow users to manipulate the resources, including affecting reservations for resources, associations of one resource with another, or allocations of resources to one or more users in a subset of users. The WMC can also provide a billing component to be sure that any costs associated with resources are appropriately managed.

Further, workplace management tools as described herein can be used in one aspect of the present invention to track and analyze usage patterns in order to facilitate wise short-and long-term space and resource decisions for businesses. Such tools enable organizations to maximize return on real estate and resource investments, optimize the efficiency of workspaces, automate the reservation and scheduling of workspaces, equipment and services, optimize tele-work and mobile work strategies, deploy a single solution across an entire enterprise, and report on space utilization and plan for future needs.

In an additional aspect, the present invention provides the integration, sensors, software and communications to facilitate business intelligence concerning actual use of business real estate and the use of space by each person. Real time, or near real time, “Actual Use of Space” data enables corporate real estate managers to deliver a highly productive, optimally-sized work environment that gives workers the space they need whenever and wherever they need to work. Measuring actual use in accordance with the present invention means recording and analyzing “presence events” as they occur. A presence event is an action that indicates a person has used their workspace. Data can be gathered from a number of workplace infrastructure systems (e.g., security systems, telephone systems, networks, motion detectors, RFID, lighting and other building controls and presence sensors) and compiled in such a way as to create an insightful composite picture of the actual use of space by workspace and by person. The integration of this data with a workspace inventory system or WMC provides the mechanisms necessary to continually monitor the actual use of space in a transparent and ubiquitous manner.

The present invention thus provides, in part, a system and method for determining actual use of the allocated or reserved space by monitoring activity through sensors, integrating the collected data with a workplace management system, then exporting that information into a specially adapted database for analysis and reporting. In this way, the present invention provides an enterprise-wide view of real estate asset usage and use of space by each person, and automates the ability of an organization to continuously, ubiquitously, and accurately measure the actual use of real estate throughout its portfolio.

In one embodiment, the present invention provides for communication between any of a large variety of sensors (e.g. video camera, infrared sensors that sense people coming through door, motion sensors that sense persons in chairs) or other sensor inputs (e.g., from security system or telephone system) and a specially adapted database. The present invention not only gathers this sensor related data, but it can take action on these presence events to manage the workplace based on business rules and other logic. For example, the present invention can be used to measure the percent utilization of the building over any time period desired (per day, week, month quarter, annual), percent utilization per organizational unit over any time period, percent utilization per workspace type over any time period, actual square feet of space used per employee, and/or time study of how the building is used throughout the day.

The present invention further includes algorithms and computer programs to analyze the collected data to measure actual presence. Combining a number of different inputs and analyzing them properly in accordance with the present invention results in a highly accurate reading of actual use.

The present invention thus assists in improving the space planning process to allow companies to reduce the total square feet of real estate needed to support a certain population, support a greater population of people in the current space, or reconfigure the space to create more of what is needed and less of what is not all based on accurate, ubiquitous, and systematically produced data. The present invention can further assist in improving business continuity by knowing who is in the building, when they were there, and where they most likely are located, and knowing the location of unoccupied workspaces in all facilities, thus allowing displaced workers from an inaccessible building to immediately find vacant workspaces to support their work. The present invention can further assist in improving the productivity of people by helping the organization to provide more of the types of workspaces that are used most often, publishing the true availability of workspaces by cancelling the assignments or bookings for spaces not actual in use thus allowing employees to find available workspaces whenever and wherever they need to work.

The present invention can be employed, for example, in commercial office space and supporting infrastructure (e.g., parking lots, technology infrastructure, business suites, conference facilities, etc.).

### BRIEF DESCRIPTION OF THE DRAWINGS

FIG. 1 is a diagram showing multiple actors interacting in a network incorporating the system of the present invention.

FIG. 2 is a diagram showing various components used in connection with one embodiment of the system of the present invention.

FIG. 3 is a chart showing different workspace resource attribute types in connection with one embodiment of the present invention.

FIG. 4 is a block diagram showing one method in which a user can manage transactions in connection with the present invention.

FIG. 5 is a block diagram showing one method in which a user can update reservations in connection with the present invention.

FIG. 6 is a block diagram showing one method in which a user can update requests in connection with the present invention.

FIG. 7 is a block diagram showing one method in which a user can manage associations in connection with the present invention.

FIG. 8 is a block diagram showing one method in which a user can manage users in connection with the present invention.

FIG. 9 is a block diagram showing one method in which a user can manage resources in connection with the present invention.

FIG. 10 is a block diagram showing one method in which a user can configure allocation groups in connection with the present invention.

FIG. 11 is a diagram showing how a user may reserve and check into a reservation in accordance with one embodiment of the present invention.

FIG. 12 is a flow chart showing the timing of certain events in connection with a reservation and check in, in one embodiment of the present invention.

FIG. 13 is a flow chart showing how the system of the present invention may be implemented.

FIG. 14 is a flow chart showing system operation in accordance with one embodiment of the present invention.

FIG. 15 shows a flow diagram illustrating voice communication control methods in accordance with the present invention.

FIGS. 16 and 17 are sample diagrams of WMC architectures in accordance with embodiments of the present invention.

FIG. 18 is a sample schematic overhead view of a single floor plan for an office building employing aspects of the present invention.

FIG. 19 is a schematic diagram of one embodiment of the overall system of the present invention.

FIG. 20 shows a schematic diagram of an implementation of one embodiment of the present invention.

FIG. 21 is a diagram showing the logical Actual Use of Space (AUS) outcomes the present invention can measure.

FIG. 22 is a sample screen shot of an occupancy monitor interface in accordance with one aspect of the present invention.

FIG. 23 is a sample interface showing floor plan occupancy in accordance with one aspect of the present invention.

FIG. 24 is a sample user interface showing summarized and aggregrated AUS BI information in accordance with one embodiment of the present invention.

FIG. 25 shows example AUS BI charts in accordance with one embodiment of the present invention.

FIG. 26 shows example user interface elements for visualizing various measurements on floorplan with individually addressable spaces (FP) using xml loaded from the Reporting Repository in accordance with one embodiment of the present invention.

FIG. 27 shows a sample floor plan (FP) with the “Utilization” option chosen in accordance with one embodiment of the present invention.

FIG. 28 shows a sample floor plan (FP) with the “Use” 138 option chosen in accordance with one embodiment of the present invention.

FIG. 29 shows a sample floor plan (FP) with the “View and Set Allocation” 141 option chosen in accordance with one embodiment of the present invention.

FIG. 30 shows a sample floor plan (FP) with the “Security Arrivals” 147 option chosen and supporting xml loaded from the repository for the 1^{st} of September as controlled by the calendar 151 in accordance with one embodiment of the present invention.

FIG. 31 shows a sample floor plan (FP) with the “Security Arrivals” 153 option chosen and supporting xml loaded from the repository for the 14^{th} of September as controlled by the calendar 156 in accordance with one embodiment of the present invention.

FIG. 32 shows a sample floor plan (FP) with the “Security Arrivals” 158 option chosen and supporting xml loaded from the repository for the 23^{rd} of September as controlled by the calendar 161 in accordance with one embodiment of the present invention.

FIG. 33 shows sample charts that can be invoked from the FP by clicking the space in accordance with one embodiment of the present invention.

FIG. 34 is an illustration of the “Zoom In” capability of the floorplan in accordance with one embodiment of the present invention.

FIG. 35 is a sample interactive chart depicting the utilization of an entire portfolio by space category and type as well as the relative size to the entire portfolio square footage in accordance with one embodiment of the present invention.

FIG. 36 is an example of the Actual Use of Space (AUS) Portfolio Visualizer of the present invention.

FIG. 37 is an alternative display of the AUS Portfolio Visualizer of the present invention.

FIG. 38 is a sample interactive chart depicting the utilization of an entire portfolio by facility and space category as well as the relative size to the entire portfolio square footage in accordance with one embodiment of the present invention.

FIGS. 39 and 40 show sample depictions of the AUS Portfolio Visualizer by Facility of the present invention.

### MODES FOR CARRYING OUT THE INVENTION

### Definitions

The following terms are defined to enhance the understanding of the invention, but the definitions contained should not be read in a limiting sense.

Administrator—a user who has the ability to configure and manipulate the system. This user can manage users, permissions and resources.

Allocation Group—a collection of specific instances of resources, which can be assigned as a descriptor of a user of the system. The allocation group to which a user belongs determines the specific resources which a user can see/request.

Archive—deactivation (not deletion) of users and/or resources from the system.

Attribute—a value associated with a resource or user. Each attribute can be assigned a value.

Authentication—a system verification of a user's ability to utilize the system.

Authorization Rules—rules that determine the type and scope of system functionality to which individual users have access.

Auto Bump—occurs when the system automatically cancels a reservation because, for example, the grace period for check in has passed.

Bump—cancellation of a reservation based on business rules, for example, a user having higher authority bumps a user with lower authority from a reservation.

Campus—refers to a number of buildings that are in close geographical proximity.

Capacity—the maximum amount of people that can be accommodated in a given space.

Catering—the provision of food and beverage service.

Check In—an indication that a user has arrived to take possession of his or her real estate reservation.

Check Out—an indication that a user has released possession of a resource.

Controlling Transaction—a controlling transaction is a transaction for a workspace of any type (e.g., conference room, cubicle, etc.). Controlling transactions can have other transactions associated with them (dependent transactions). The success or failure of the controlling transaction determines the success or failure of its dependent transactions.

Dependent Transaction—a transaction associated with a reservation for resource.

Facility—a physical building that houses real estate managed by the present system.

Grace period—the maximum time allotted from the start time of a reservation to the time when a reservation can be, e.g., automatically bumped by the system.

Hoteling—sharing of office workspaces and resources.

Lead Time—the amount of up-front notice required by the system before a request for resource is allowed to take place. For instance, a request for catering may require a 24-hour advance request.

Login information—information required by the system to begin a session.

One-click reservation—typically a user's most frequently created reservation, this reservation can be created with one user action, such as a mouse click, according to a pre-defined set of required criteria for the reservation.

Permission—an authorization or approval to manipulate transactions within the system of the present invention.

Preference—user-established values that enable one-click reservations, best-fit alternative selections and other system functions.

Profile—a collection of user information.

Race condition—occurs when two or more users simultaneously access and try to request the same resource.

Reservation—the temporary assigning of a resource to a user requesting the resource for a period of time.

Resource—an asset or service that is managed by the present system.

Resource category/Resource type—the general and specific examples of resources. For example, a workspace is a category and a cubicle is a workspace type.

Time block—This described the range of time between the start time and end time of a user's request for a resource.

Time slot—This describes the interval of time that is used to segment requests and reservations at a more granular level. For instance, a reservation for 1 p.m.-2 p.m. may actually consist of four fifteen-minute time slots.

Voice Communication System—a telephony switching device that allows phone extensions to be assigned to a physical location, such as PBX (Private Branch Exchange), Voice over Internet Protocol (“VoIP”), etc.

Waitlist—a mechanism for allowing users who have requested an unavailable resource to be placed on a priority list for reserving the resource, should it later become available.

Workspace—a reservable space resource.

Workspace Management Component and Operation

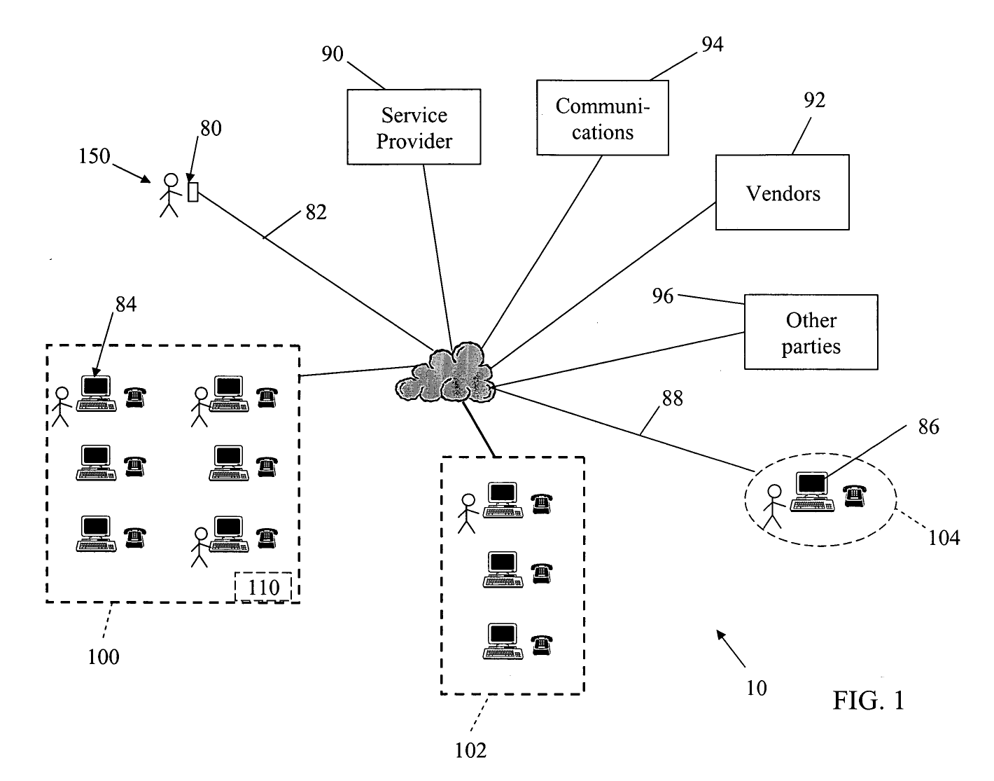

As shown in FIGS. 1 through 17, there is provided a workspace management component (WMC) 10 for managing workplace real estate and resources. In FIG. 1, a single business is shown which may extend across multiple offices 100, 102 to remote users 104 (accessing, e.g., from their homes) and users 150 who may need to access the corporate network via wireless device, for example. The network can be any of a variety of hardware, software and communications technology designed to facilitate corporate information processing. In one embodiment, the main server farm 110 is located at office 100, and can include typical office suite software, internal and external (e.g., Internet) network access capabilities, security, corporate web server, transaction server, e-mail server, as well as an application server for assisting in the execution of the present invention.

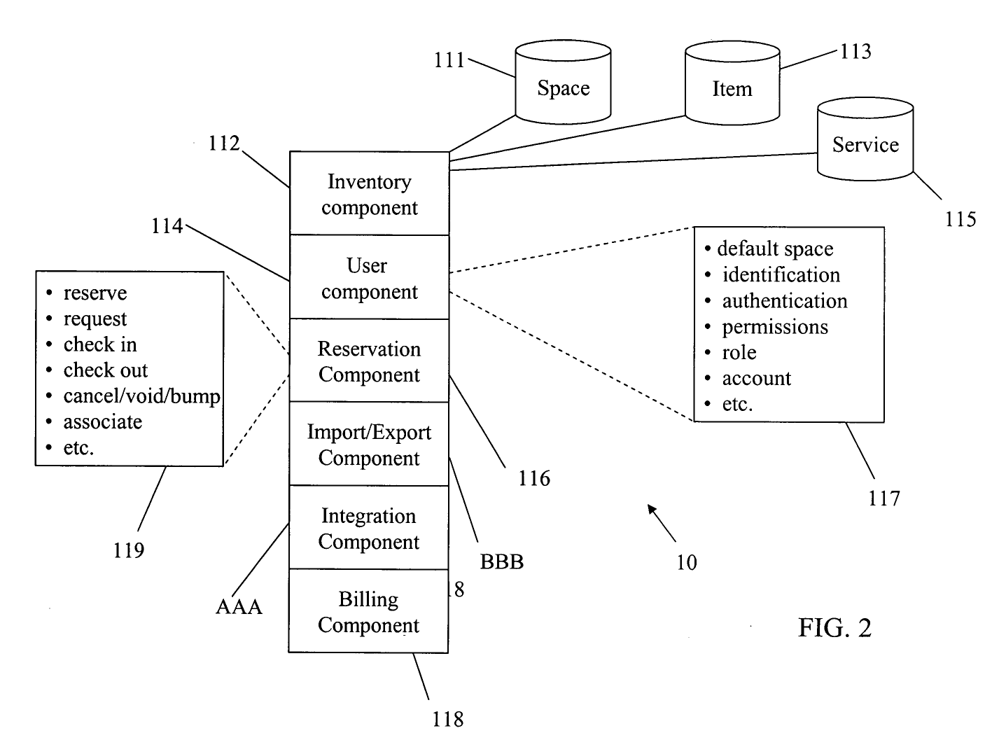

As shown in FIG. 2, the WMC includes an inventory component 112, a user component 114, a reservation component 116, a system integration component, a data import and export component and a billing component 118. The inventory component can store and access information about every reservable resource, whether that resource is (1) physical workspace 111, such as a cubicle, conference room or training room; (2) a physical item 113, such as food and beverage, computer, telephone, writing implements; or (3) services 115, such as catering, photocopying, or courier services, or network or voice connectivity. Within the inventory component, the WMC can store default information related to each employee or worker. For example, if office 100 has 75 workspaces and 70 employees, the inventory component can store information about each employee and his or her respective primary or default work space. In this way, the WMC can know what workspaces will not be available for reservation by default, i.e., with no worker movement. In one embodiment of the invention, users are not provided with any default workspace, but may have priority or exclusive rights to reserve their workspace on a regular basis.

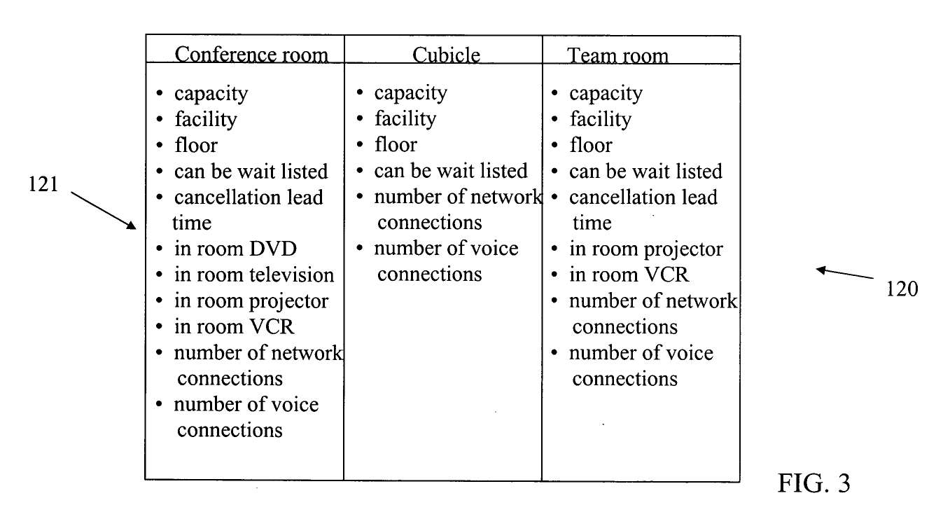

The inventory component 112 can also store information about each work space type, such as the various types of resources that are available based upon the type of workspace being reserved. As shown in the diagram 120 in FIG. 3, for example, a DVD player may be available in a conference room as at 121, but not at a cubicle. Also, the inventory component can store information related to costs for using each resource, whether costs are always assessed, and when to invoke late cancellation charges.

The user component 114 stores information 117 about each user, including the user's role, identification, authentication credentials, permission information, and other user-specific elements. The user's role can be one of the following roles, for example: administrator, concierge, user, service provider, or equipment provider. The user's identification can be the user's name or employee number, for example. The user's authentication credentials can be a password, private key, or biometric identification, for example. The user's permission information can determine what the user can access, and can be determined on a default basis by the user's role, or can be customized based on the user's needs, for example. The user's permission information can also include information about specific associations or groups to which the user belongs and which allow the user to make special reservations as will be described below. Other user-specific information can include physical item requirements for the user at his or her workspace, computer and telephone preferences and other preference information (e.g., window office, near kitchen, indirect light). In one embodiment, the user component includes previously stored information describing the user's preferred parameters for a reservation including facility, workspace type, specific resource or resource type, day or date, time and recurrence, for example.

The integration component 105 provides the mechanisms for real time input from and output to various sensors and other systems. This component allows the WMC to take various actions such as make checkin, checkout, bump, cancel, switch phone, detect presence, and other actions necessary to manage the facility and operationalize the data gathered to increase its accuracy. Without the integration component, the system would simply rely on data gathered from sensors and not be able to add the critical capabilities of taking actions to support the business rules and operations so vital to maintaining accurate actual use data.

The data import and export component 107 provides the mechanisms for batch input from and output to various sensors and other systems. This component complements the integration component for those data sets that are less time sensitive. This component allows the WMC to take various actions such as make checkin, checkout, bump, cancel, switch phone, detect presence, and other actions necessary to manage the facility and operationalize the data gathered to increase its accuracy. Without the data import and export component, the system would simply rely on data gathered from sensors and not be able to add the critical capabilities of taking actions to support the business rules and operations so vital to maintaining accurate actual use data.

The billing component 118 stores information related to billing. This can include charges incurred by users of various workspaces, resources and services.

The reservation component 116 allows users to interact with the inventory component so as to reserve or request resources, check into or out of a reservation, cancel or void a reservation, or conduct other types of transactions as at 119, and as herein described. The reservation component can also be called the transaction engine. The voice component 118A handles voice communication services and transfers in connection with the present invention as described in more detail hereinafter.

Transaction Management

The WMC includes transaction management capabilities for handling a wide range of activities, including manipulating the items in the inventory. For example, users can check resource availability, create and modify requests for resources, and check into and out of reservations. Users can also allocate resources to specific users or user groups, or associate a specific resource with an already made reservation. Resources can include a variety of items such as conference rooms, cubicles, computers, or catering, for example.

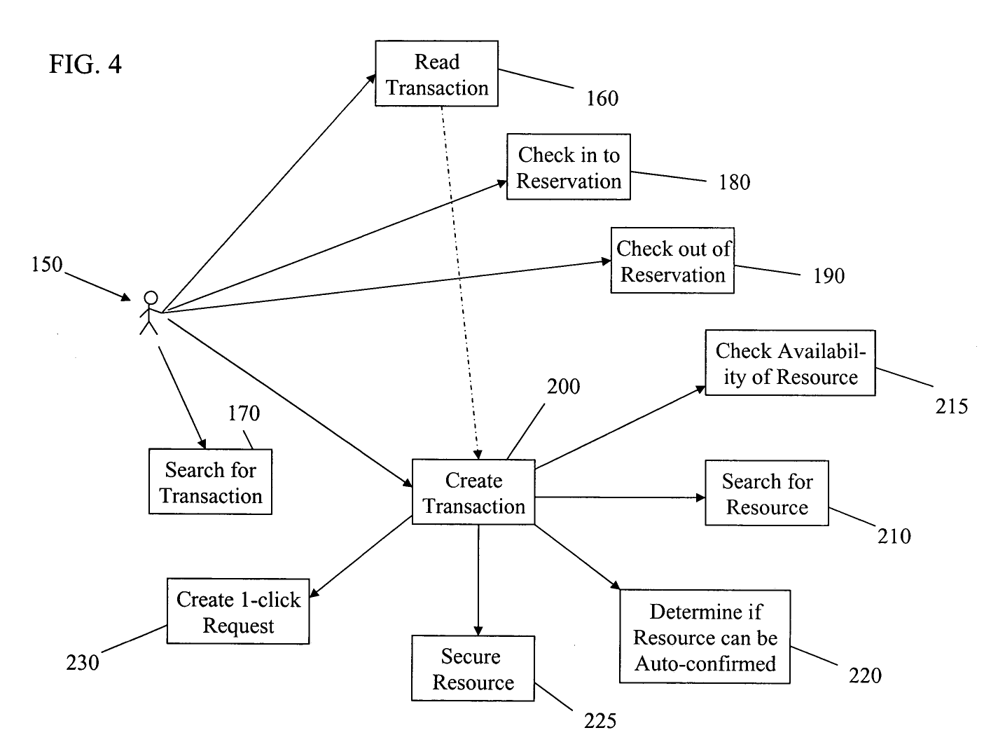

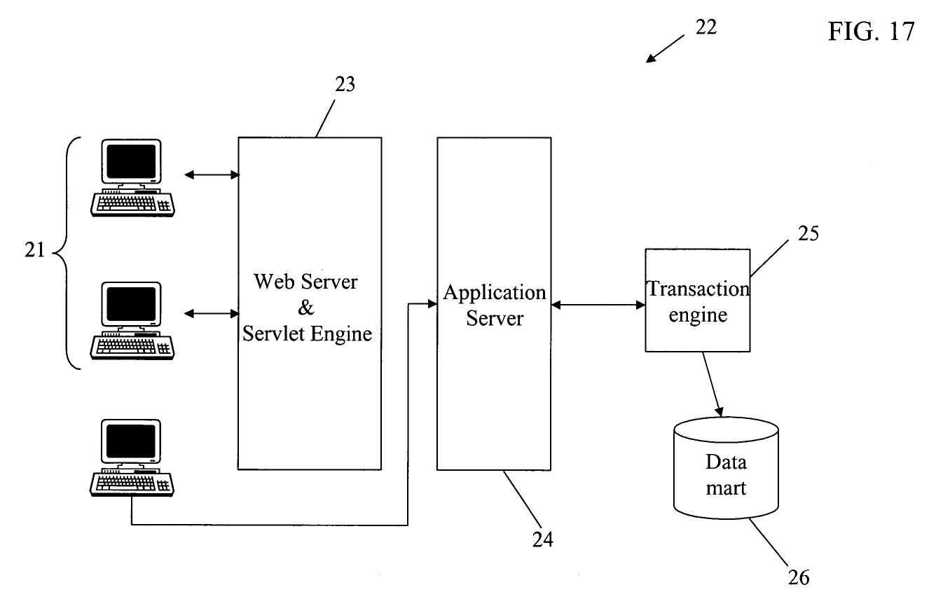

FIG. 4 shows a graphical representation of some of the user's transaction management capabilities in connection with the present invention. The user 150 can be an administrator, an employee, a concierge or other entity given authority to access the system of the present invention. In one embodiment of the invention, as shown in FIG. 17, the system architecture 22 of the present invention incorporates a web server 23, application server 24, transaction engine 25 and data mart 26. In one embodiment of the invention, the user can access the system via the Internet or other network using a web browser 21 at their workspace, mobile device, home or kiosk. The voice communication controller discussed later herein can directly access the application server 24.

At 160 in FIG. 4, the user can read a previously established transaction, whether that transaction is a past or present request, reservation or order. In one embodiment, the user must first be authenticated and authorized before having read capabilities. Authentication can be through any of a variety of commonly known authentication procedures, such as password, key encryption or biometric authentication. Authorization can also be via any of the commonly known authorization techniques, such as the pre-registration of the user into a defined category having particular access authority associated to the class. When searching for a particular transaction, the user can be provided with search parameters, such as type of transaction, originator of the transaction, or dates surrounding the transaction, for example. Once the user specifies the search parameters, the present invention will search for the transactions matching the specified parameters and further being permissible for the user to view, as shown at 170. Upon viewing the returned results, the user can select the transaction to view/read.

As shown at 180 and 190, respectively, the user can also check into or out of a reservation. In these cases, the user can be authenticated and authorized as before, and will have previously established and confirmed a request for workspace. Upon deciding to check in, the present invention presents the user with a listing of outstanding reservations to which the user has not previously checked into or out of. Upon selecting the desired reservation, the present invention presents a confirmation to the user, notifies all additional applicable parties, and records appropriate metric information for later system use.

In one embodiment of the present invention, the user can be a mobile worker accessing the system via a mobile device having a browser or the like. In another embodiment of the invention, the user can check in via local kiosk. In a further embodiment, the user can check in via calling or otherwise communicating with a system concierge, who may or may not be locally present at the check-in location.

The system of the present invention can accommodate early and late arrivals for scheduled reservations. In one embodiment, user telephone service can be switched immediately upon the user's arrival, but the user's start time for billing purposes would not begin until the reservation time. In a further embodiment, the user's start time for billing purposes would begin at the actual check-in time if the user was checking in unusually early, such as, for example, more than one time slot earlier than the actual reservation time. The invention can be customized to allow business rules to determine when voice communication profiles are transferred or when billing will begin, for example.

Upon checking out of a reservation as at 190, the user is informing the system that he or she is relinquishing possession of a workspace, and similar procedures to the check-in case follow. If the user has extended his or her stay beyond that originally reserved, the system of the present invention will allow this as long as there are no other reservations having priority over the reserved space or facilities/resources. The system will also track time used for billing purposes, and in one embodiment will not re-transfer phone systems back until the user has checked out.

As shown at 200, the user can create a transaction for the purposes of researching or requesting reservation of resources. The user can be prompted with questions which help the system pinpoint the type of resource the user is seeking. The system can then search for the desired resource, as at 210. Upon finding the desired resource, the user can query as to the availability 215 of that resource given the user's particular requirements. If the resource is available, the user can inquire as to whether the resource can be confirmed without requiring additional human approval, as at 220. If so, the resource is then reserved for the given location, time and date specified by the user. The system then blocks that resource's availability from other inquiring users for the specified time and date, and can send a confirmation to the user as well as notification to other appropriate parties, as at 225. If the resource requires additional human approval, such as the administrator or a department head, for example, such person(s) would be notified as determined by the system and, upon their approval, the above reservation procedures would occur. In one embodiment of the invention, if two or more users simultaneously access and try to request the same resource, one or more of the parties may lose the desired resource due to another user making the reservation first. This is known as a race condition; thus, it is important for the user to realize that the resource may or may not still be available until the reservation is confirmed.

In another embodiment, when the transaction is created for a resource other than workspace, the system of the present invention creates an independent transaction, i.e., a transaction not tied to any other resources. Where the transaction is created for a workspace, the user can be given the opportunity to request other resources which will become dependent transactions, i.e., they are related to the workspace transaction, which becomes the controlling transaction. In this way, the user can cancel a given transaction for workspace, and the dependent transactions related thereto will become automatically canceled.

As shown at 215, the user can check the availability of resources by answering a series of questions about the resource desired, including, for example, the frequency of their request (e.g., daily, weekly, monthly). The questions presented can follow a pyramidal approach, such as by having the user define the resource category first, then the resource type within the selected category, and the date/time/location information to meet the user's needs. In one embodiment, the questions are presented within a user interface that can be simply manipulated for limited input environments, such as mobile phones. For example, the interface may include simple selection buttons corresponding to numbers on the user's phone, as opposed to text entry boxes. In another embodiment of the invention, the information returned by the system can include the closest matches for the request, if there are no direct matches.

In one embodiment, as at 230, the user can pre-store information in the system corresponding to the user's most commonly requested reservation. Upon storing this information, the user can then direct a “one-click” transaction search and request. In one embodiment, the user's one-click preference information includes day of week, start time, end time, facility, neighborhood and resource. The one-click reservation can be implemented using a single mouse-click, for example, or a touch screen, voice-activated or other single action that signals the system to reserve the resource.

At all times, deviations from common system functions are accounted for. For example, if there are no reservations pending for a user, the system can so notify the user upon the user desiring to check in.

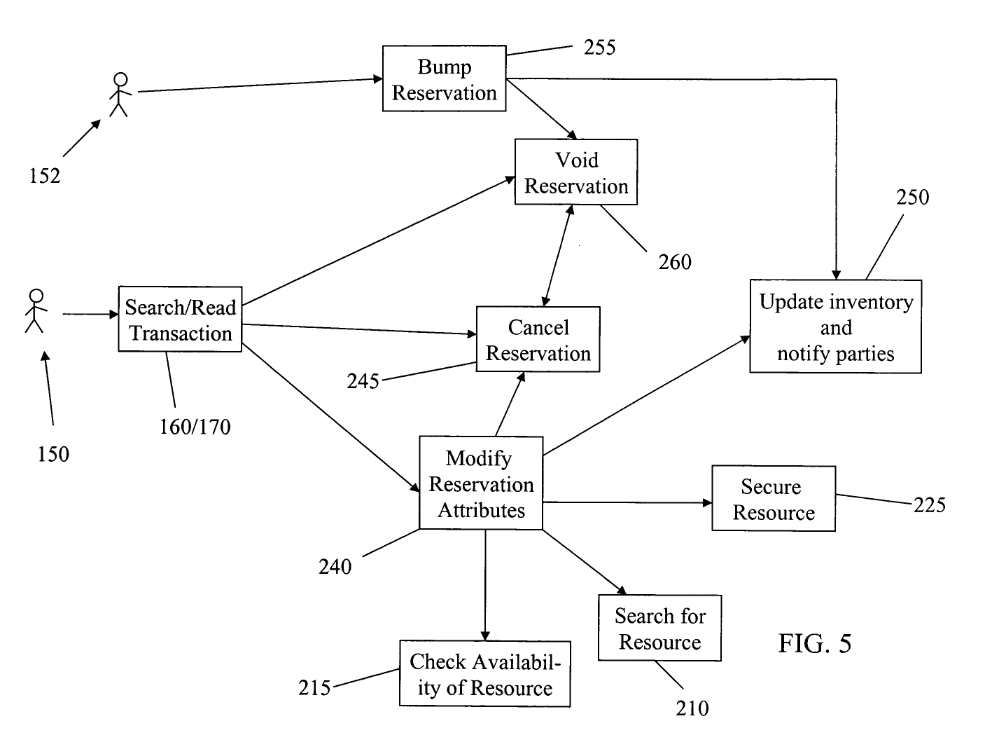

As shown in FIG. 5, users can update existing reservations and/or orders. These types of functions can include altering the time or location of a reservation or an order. Further, the altering of a controlling transaction (e.g., a workspace reservation) can affect the dependent transactions related thereto. In one embodiment of the invention, users are prevented from changing reservations where they have already checked into the reservation or where the start time has already passed.

A user 150 indicating to the system that he or she wants to modify an existing reservation 240 or order can be provided with a menu of current reservations. Upon selecting the particular reservation of interest, the modifiable parameters associated with the reservation are presented. Once the user has changed the desired parameters, the system invokes the functionality provided by the check availability function 215 to determine if and how the user's requested changes affect the resource's availability. If a search for a new resource is involved, search function 210 and secure function 225 can be invoked. Depending on the circumstances, the system can also cancel the user's original reservation as at 245 and makes available to inventory any resources not part of the revised reservation as at 250. Also at 250, the system notifies the inventory of any resources newly restricted by the revised reservation, including dependent transactions. All appropriate parties are notified and confirmations can be sent.

If a conflict results from a desired reservation change, the system can notify the user and request alternative reservations, or the system can take previously stored default decision information related to the user to make the best fit from the options available for resolving the conflict. In one embodiment, the user can be prompted to confirm that the changed reservation will result in one or more dependent transactions being dropped and that this is acceptable. In a further embodiment, the system checks for “best fit” by resource-type and time block. For example, if the resource is a conference room, the system can see if other conference rooms are available.

As further shown in FIG. 5, a user 152 can employ the system of the present invention to bump 255 a reservation. Bumping 255 a reservation involves ending another user's confirmed reservation against their wishes. Bumping can occur after the start time of a reservation but before the end time. Bumping is typically initiated by a user 152 having a higher status than the original user, such as one having permission to bump certain levels of reservations. Once the reservation has been bumped, the system notifies all necessary parties, frees all previously reserved resources, and notifies all other necessary systems, such as the voice communications systems. In one embodiment, the system of the present invention can be programmed to automatically bump reservations based on defined circumstances (e.g., check-in has not occurred within 30 minutes of start time).

Canceling 245 ends a reservation and can be performed by the originating user 150 or user 152. Canceling can be configured to occur prior to the start time or during the reservation. In one embodiment, the system can allow a concierge or other agent for the user to cancel the reservation. Such instances may require that the agent use a special code or password to effectuate the cancellation. In a further embodiment, the system can be programmed to require lead time in order to end the transaction and therefore release the canceling user from financial responsibility for the reservation.

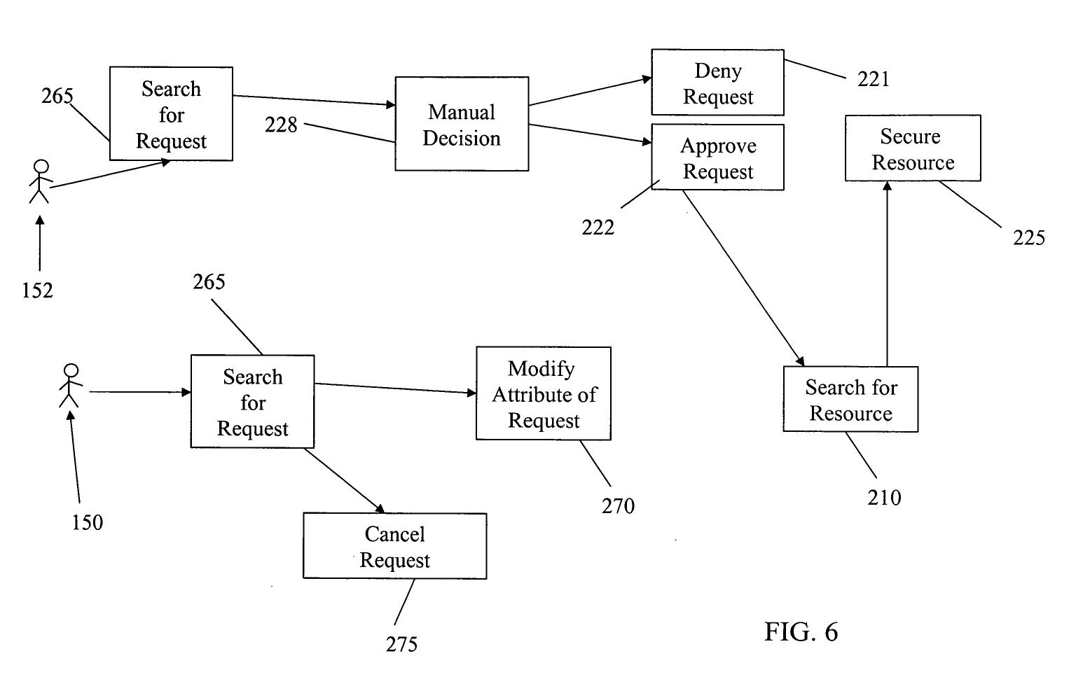

As further shown in FIG. 6, the system can allow the user 150 to modify an existing request which has yet to be confirmed as a reservation by the system. In such a case, the user can request at 265 a listing of current requests and can select the particular request desired to be modified. Once selected, the user is provided with the parameters which can be modified, and the user makes the desired changes, as at 270. The system accepts the desired changes, and the user's original request can then be canceled as at 275.

In one embodiment of the present invention, requests are not immediately confirmed but require authorized user 152 approval. Upon logging in to the system, the user 152 can then select the requests 265 where he or she chooses to make a manual decision 228 and can then approve 221 or deny 222 the request. Upon approval, the system determines availability 210 for the request and if available the system reserves the resource requested as at 225. The requestor is then notified and can act accordingly as previously described.

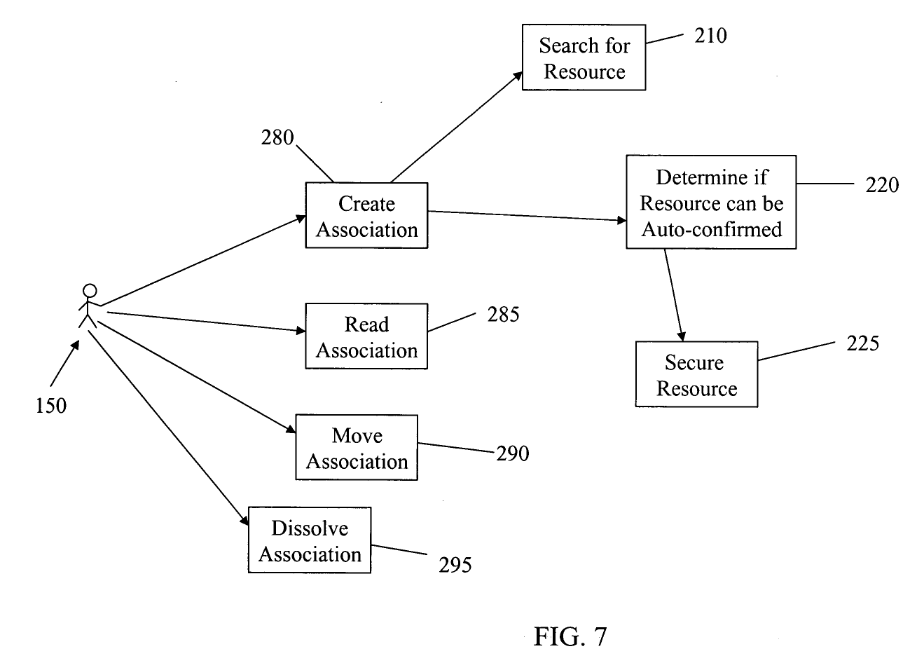

As shown in FIG. 7, associations can also be created, read, moved and dissolved. Dependent transactions can also be removed or added as necessary. For example, in creating an association, as shown at 280, a user may already have one or more reservations pending in the system, and may wish to add a resource to one of the reservations. Upon directing the system, the user can search for resources as at 210 which match his or her needs and, if available and securable, can tie the additional resource to the existing reservation. For example, if a user has requested a workspace but no other resource, the user may wish to search to see if an additional resource is available. If so, that resource can be added to the existing workspace reservation.

Similar to reading a transaction, the user can also select to read an association, as shown at 285, whereby associations of transactions can be listed for the user to select from. Upon making a selection, the user can see all previously created transactions within the selected association.

Similar to changing a reservation or existing transaction, moving an association, shown at 290, allows the user to change a transaction for space (a controlling transaction) and all dependent transactions. In changing the parameters of an association, the corresponding parameters of the individual transactions are also changed. For example, changing the date an association is set to occur will change the start time for all of the transactions grouped within the association. In one embodiment of the invention, the association cannot be moved if the start time has already passed.

Similarly, dissolving an association, shown at 295, allows the user to cancel the entire association by dissolving the primary or controlling transaction. For example, the user may dissolve an association of conference room facilities, network connectivity, video-conferencing and catering over a two-day period by simply canceling the conference room facilities. Once canceled, the remaining dependent transactions are also canceled by the system, and the system inventory is updated to reflect the newly available resources.

Dependent transactions can be added and removed from controlling transactions in a similar fashion. Upon searching for user-related associations, the user may desire to add an additional resource as a dependent transaction from a controlling transaction, e.g., adding a projector to a conference room reservation. The system can search for and confirm the availability of the resource to be added, then notify the appropriate parties and update its inventory to allow for the newly taken resource. Similarly, the user may later remove the projector equipment from the conference room reservation.

It will be appreciated that many of the functionalities invoked by the present system can be re-used for different user needs. For example, the system can use the “Search for Request” and “Cancel Reservation” functionality when the user desires to modify a request. In this way, many portions of the programming involved in the present invention are maximized for use.

User Management

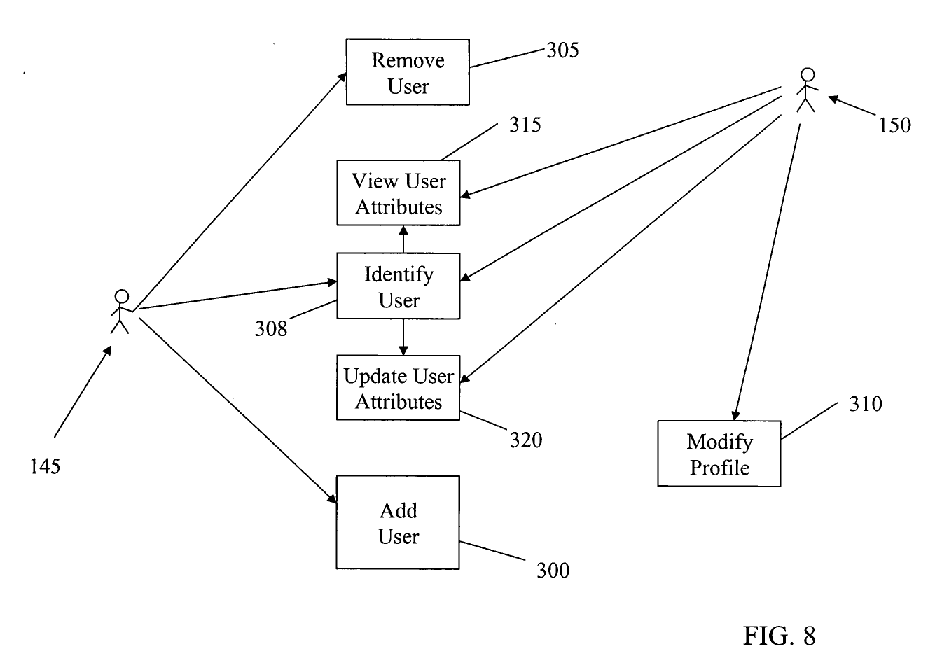

As shown in FIG. 8, the system of the present invention allows user and user types to be created and removed. Each user can further be provided with profile information to assist the system in processing user-specific requests. In one embodiment of the invention, the system first designates an administrative entity 145 or entities having rights to create 300, remove 305, identify 308 and modify 315, 320 user information.

In establishing a new user to the system, as shown at 300, the administrator can add user demographic information, profile information, the user's role, the user's allocation group, and other user attributes. The user's role can be, for example, administrator, concierge, mobile worker, knowledge worker, etc. The system can allow the administrator to establish user information based on pre-defined fields and parameters, or based on administrator-defined fields and parameters. The system can also have pre-defined authorization levels based upon the user's status or role. The newly defined user 150 can also review 315, update 320 and approve the information stored in his or her profile. If the information needs to be modified from time to time, the user, administrator or concierge can do so, as at 310. Modifying a profile can include establishing a user's “one-click” preference information for use when creating a transaction.

Users may also use the present invention to search for other users having a given profile, or for the current location of a given user based on existing reservations.

Resource Management

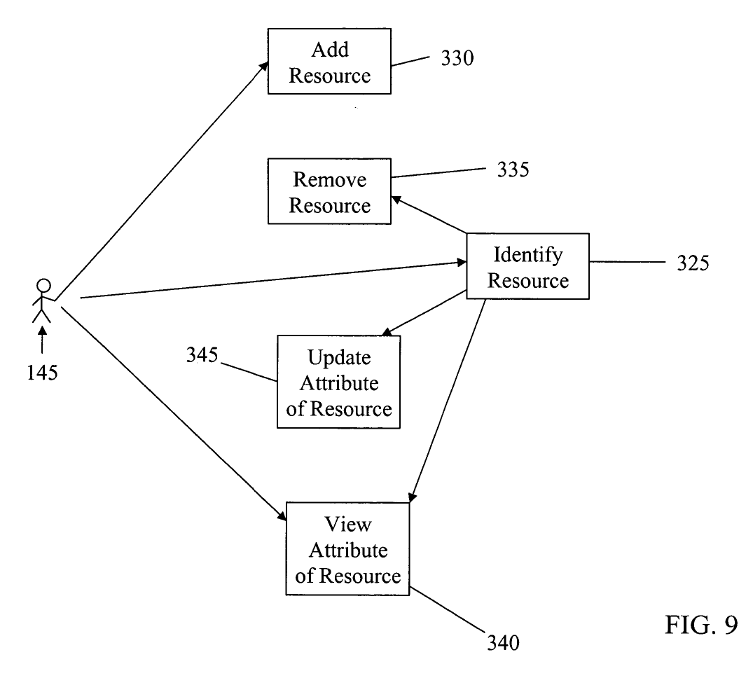

Just as users can be added, removed or modified, resources can be added, viewed, identified, modified and removed, as shown in FIG. 9. Administrators 145 can add resources (330) to, or remove resources (335) from, the inventory of resources. Resources can be added from a pre-defined list or based on a user's specific needs. Once added, the resource must be given attributes that define its behavior in the system. Attributes can be viewed 340 and updated 345 for existing as well as newly created resources. For example, there may be pre-conditions for the resource's availability, or the resource may not reduce inventory if selected (e.g., writing instruments at a workspace). System reporting can determine usage rates of various resources and associated business procurement needs. If custom user or resource attributes are implemented, the implementing user must specify the data type and format of the new user attribute.

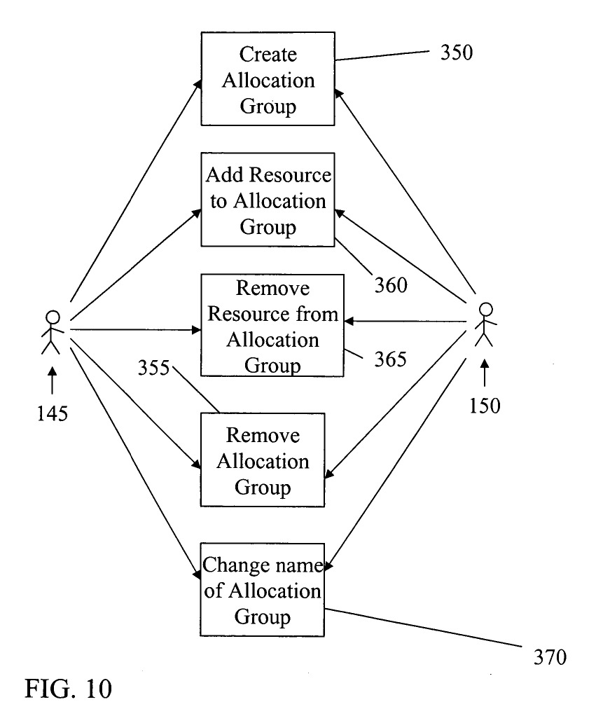

As shown in FIG. 10, allocation groups can be created 350, removed 355 and modified (as at 360, 365 and 370) and can further incorporate users or resources. Allocation groups are groups of resources which are so grouped so as to restrict which instances of resources users of the system of the present invention are able to see and/or request. For example, if a series of workspaces are labeled the “Project Finance group spaces,” creating a reservation for such series may be limited to those members of the Project Finance team. Both resources and users can be added and removed from allocation groups.

Thus, in one embodiment of the present invention, the entirety of system users may have access to a certain subset of system resources, a subset of system users may have access to separate system resources, and individual users may be provided with exclusive access to particular system resources. For example, a corporate vice president can have her workspace allocated specifically and only to her, thereby allowing her to reserve that workspace routinely as desired. The same vice president may be part of a group of users having the ability to reserve the corporate board room. Further, the vice president would be part of the universe of users capable of reserving a laptop computer, for example. In those instances where a user's allocation has no available resources, a concierge user can make a reservation for that user employing the broader concierge's allocations.

It will be appreciated that appropriate business rules may be associated with the management of transactions, users, resources and system implementation. For example, if a user is not allowed to bump his or her own reservation, that is a business rule affecting the management of transactions. The present invention can be provided with its own set of modifiable business rules. In another embodiment, the present invention can be provided with no set business rules, whereby the administrator can establish all business rules affecting system management.

Kiosk Interface and Other Interfaces

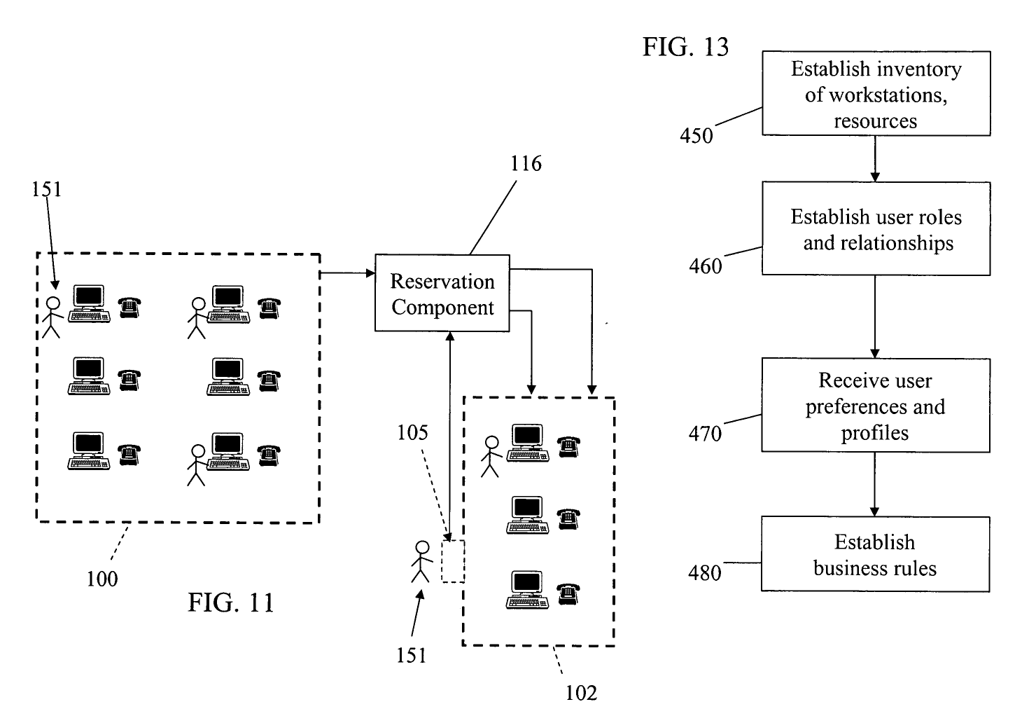

In the physical layout of one embodiment of the system of the present invention, computers displaying the Kiosk Interface 105 can be placed locally at or near the entrance to a facility 102, as shown in FIG. 11. The system's Kiosk Interface allow users to quickly access frequently used system functions. For example, through a Kiosk Interface, a user may create a “just in time” reservation or a “one-click” reservation, check into or out of a reservation, cancel a reservation, or locate a resource, reservation, or person.

In a typical embodiment of the present invention, the Kiosk Interface of the system operates on a computer equipped with a touch screen monitor that allows the user to use touch-sensitive controls to enable system interaction and resource manipulation via fingertip. Because the Kiosk Interface is a browser-based interface, it may be deployed anywhere network connectivity exists. Touch screen interfaces are commonly known, but not deployable as a browser based interfaces. By the present invention, floor plans and other diagrams and icons representing system resources can be presented as bitmap, gif or other computer graphic images and used to make system function much easier to control and to provide a useful format to display database information to the user. Similar icons and graphical representations can be represented and manipulated on a wireless device interacting with the present invention.

As shown in FIG. 1, the system can be accessed through multiple interfaces over a variety of communication networks. For example, a user can access the system via a properly equipped wireless device 80 over a wireless network 82, via standard network computer 84 over the internal network, or via remote computer 86 over the Internet, an extranet or other public/private network 88. Service providers 90, vendors 92, communications providers 94 and other outside parties 96 can access the system in similar ways. For example, in one embodiment of the invention, outside parties could be allowed to rent excess workspace. Appropriate firewall and other security can be implemented to allow such outsiders to use standard business computing components. In a further embodiment, users of separate systems can access resources of the other system. For example, an employee of Company A having a certain role and privileges for manipulating resources within Company A's management system, may be allowed to access Company B's management system in the role of an outside user. As such, the Company A employee may be able to reserve temporary workspace while on travel.

In one embodiment, the present invention accommodates such circumstances whether the outside user situation is private-to-private, private-to-public, public-to-private, or public-to-public. Further exemplifying, private-to-private access can occur with a user from a corporation at location A seeking to manipulate resources from location B. Private-to-public access can occur when user from Company A seeks to use public resources made available such as by a tele-work center. Public-to-private access can occur when the public user seeks to manipulate or reserve resources from Company A's private management system. Public-to-public access can occur when an unaffiliated user seeks to interact with resources generally available and not private.

WMC Reporting

It will be appreciated that through the interaction of the many users of the WMC of the present invention, valuable data can be derived. The WMC of the present invention can be provided with data management and reporting capabilities to address the information needs of the concierge, office managers, facility managers, business/line managers, database and system administrators, fulfillment agents, and senior executives. For example, reports may be provided for past system usage on a daily/weekly basis, or for future estimated system use. Reports may be customized based on user type, resource type, request type, reservation type, workflow, or type of device making the reservation, for example. Through report analysis, better business decisions can be made to ensure system up-time, utility and profitability. Actual use of space reporting as described hereinafter is facilitated by the WMC of the present invention.

In one embodiment of the invention, the WMC can use an on-line entry database having the more complex table structure for adding and modifying on-line data, coupled with a reporting database having a modified table structure designed to minimize table joins and maximize processing speed. Data archiving and historical transaction data collection can be achieved through methods presently known in the art.

FIG. 11 shows one embodiment of a method employing the WMC of the present invention whereby a user 151 from a first facility 100 interacts with the reservation component 116 of the present invention to reserve a conference room at a second facility 102. The user 151 is presumed to have been appropriately added to the user database and provided with appropriate authorization credentials and permissions.

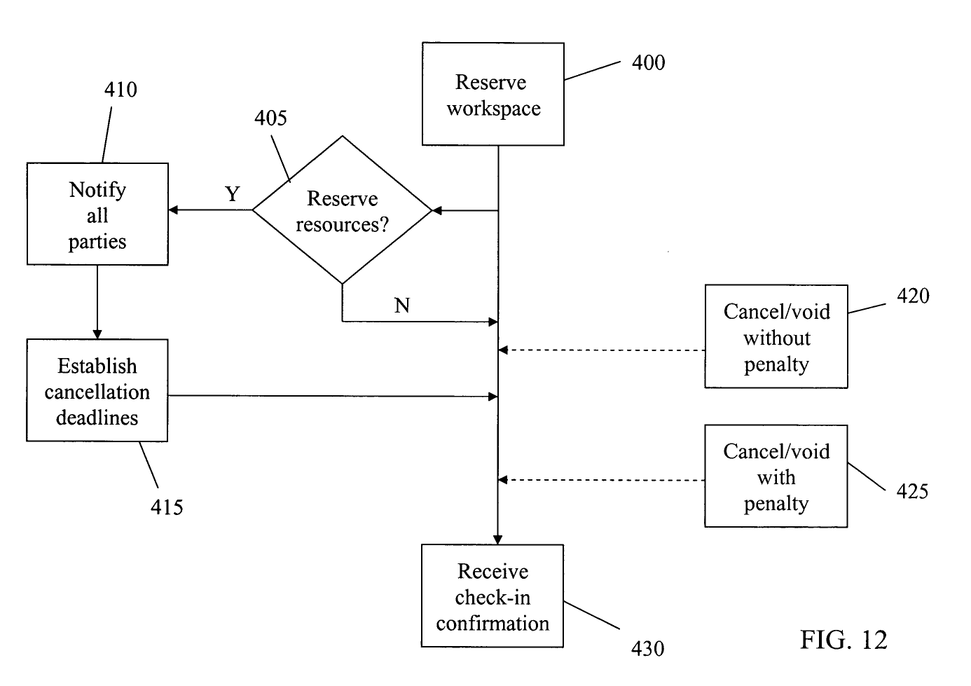

As shown in FIG. 12, once the user has reserved the workspace (at 400), he or she is prompted to reserve additional resources, as at 405. If, for example, the user has requested catering for eight people, network connectivity, a VCR, a television and voice service, several outside parties may be notified in advance of the user's reservation, as at 410. At 415, cancellation deadlines may be established whereby the user will be held financially responsible if attempting to cancel an order or service beyond the deadline, as at 425. If the user cancels the reservation for the order or service prior to the deadline, there is no penalty, as at 420. Once the user checks in at 430, resources which need no advance set up can be transferred to the user's workspace. For example, if a network or voice connection needs to be flipped or bound to the physical resource at the workspace, this can take place nearly instantaneously with the user's check in.

Referring back to FIG. 11, the user 151 may check in at a kiosk 105 provided at the facility 102 where his workspace is reserved. In one embodiment of the invention, the kiosk 105 can be provided at one building of a combination of buildings. In this “campus” mode, the user can check in at the kiosk provided at a first building for a reservation at a second building within the same group of buildings. This is highly desirable for companies employing a campus-like work environment.

As shown in FIG. 13, system implementation involves establishing the inventory of workspaces and resources as at 450, as well as the user roles and relationships 460. Once the fundamental players are defined, customized features can be provided such as user preferences and profiles 470 and specific business rules 480.

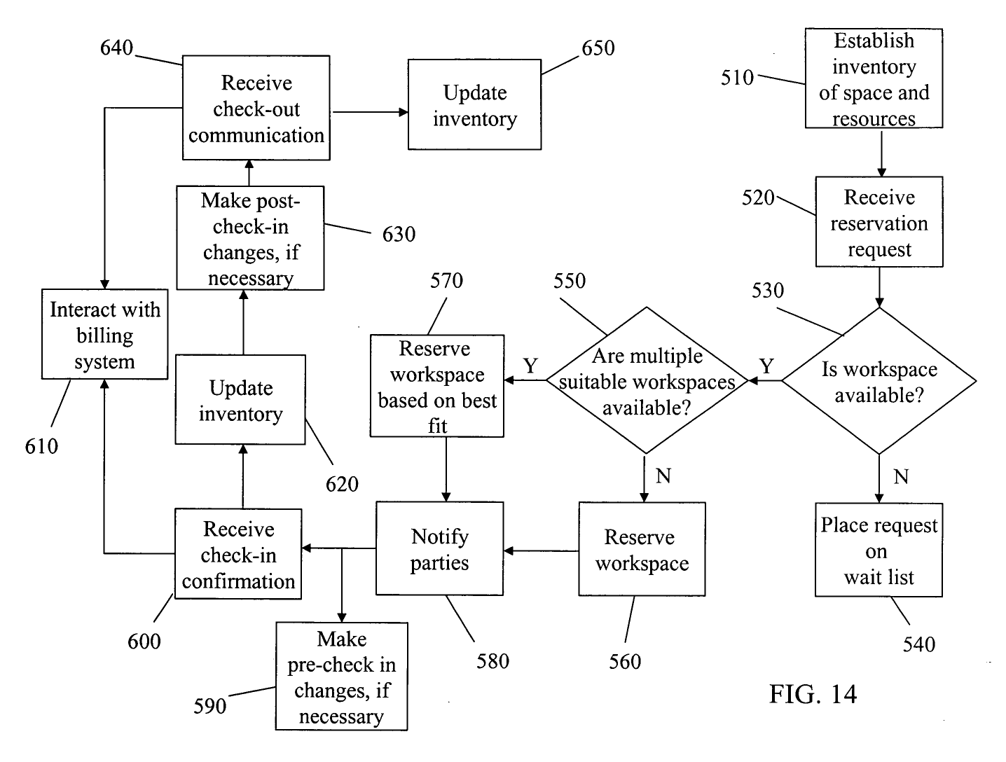

FIG. 14 is a flow diagram showing system interaction among the various components during a reservation sequence. As at 510, the inventory of resources is established. At 520, a previously registered user may select for a reservation any resource in his or her allocation. The system checks its inventory of resources at the requested facility to determine if a resource is available, as at 530. If not, then the system can notify the requesting user and the requesting user can try a different search. Alternatively, the system can put the user's resource selection in a wait-list for a resource at the requested facility, as at 540. The resource can be waitlisted automatically or after being directed by the user, as long as the resource is configured to be waitlist-able.

The WMC determines if multiple resources will exactly satisfy the user's selection criteria, as at 550. The user then selects the specific resource desired. If there is no exact match for the resource selection criteria, the system will perform a “best fit” search as at 570. Best fit can be determined by giving the requesting user a choice among several resources that best fit the user's specific resource criteria. The user then can select the specific resource desired.

Once the reservation is made, appropriate parties are notified as at 580 and the system inventory is updated to reflect the now-taken resources for the given time and date. For example, any attending users, support staff, service suppliers and other parties can be notified via e-mail or other communications method deemed appropriate. Before checking in, the user can request changes as at 590 to resources or space as long as the user has been given authorization. Once the user has checked in to the reservation as at 600, the billing component may be notified as at 610 to track the user's occupancy and other potential charges for resources. It will be appreciated that, while the billing component may be most frequently tied to check in and check out, the billing component may interact with the reservation system on more occasions.

Once the user has checked in, the inventory of space and resources can be updated as at 620 to reflect at least the user's current releasing of his previously occupied space, which may be his default workspace. If the user then requires post check-in changes to resources, he may request them to the extent allowed as at 630. Upon check out at 640, the billing component may again be notified, and the system inventory is updated as at 650 to reflect the change in occupancy status of the resource which had been checked into and the resource to which the user next goes.

Voice Communication Controller

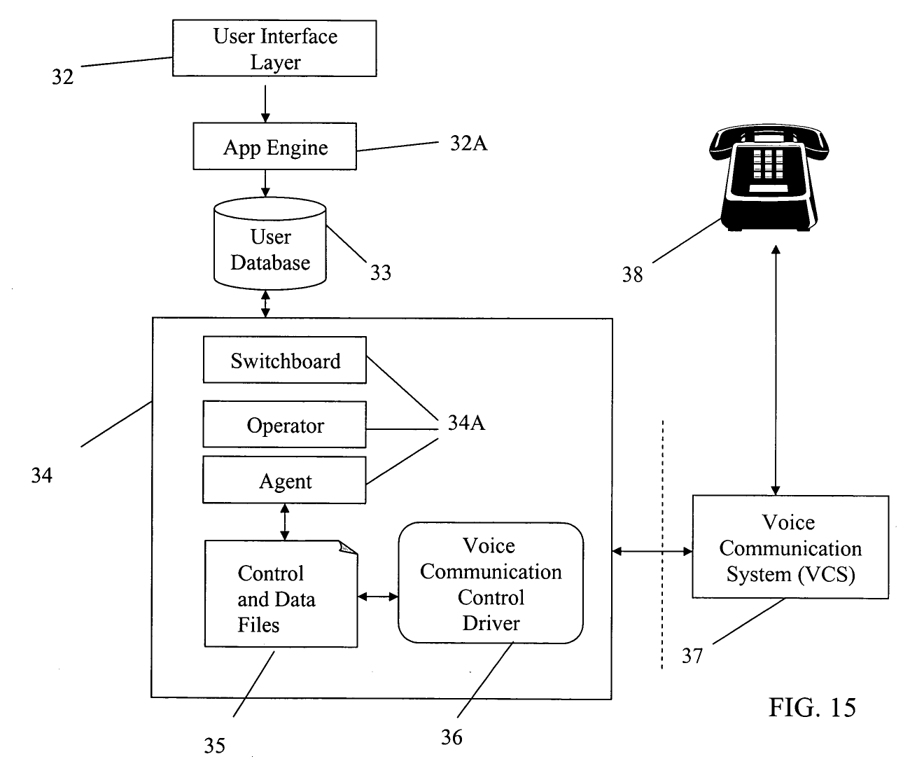

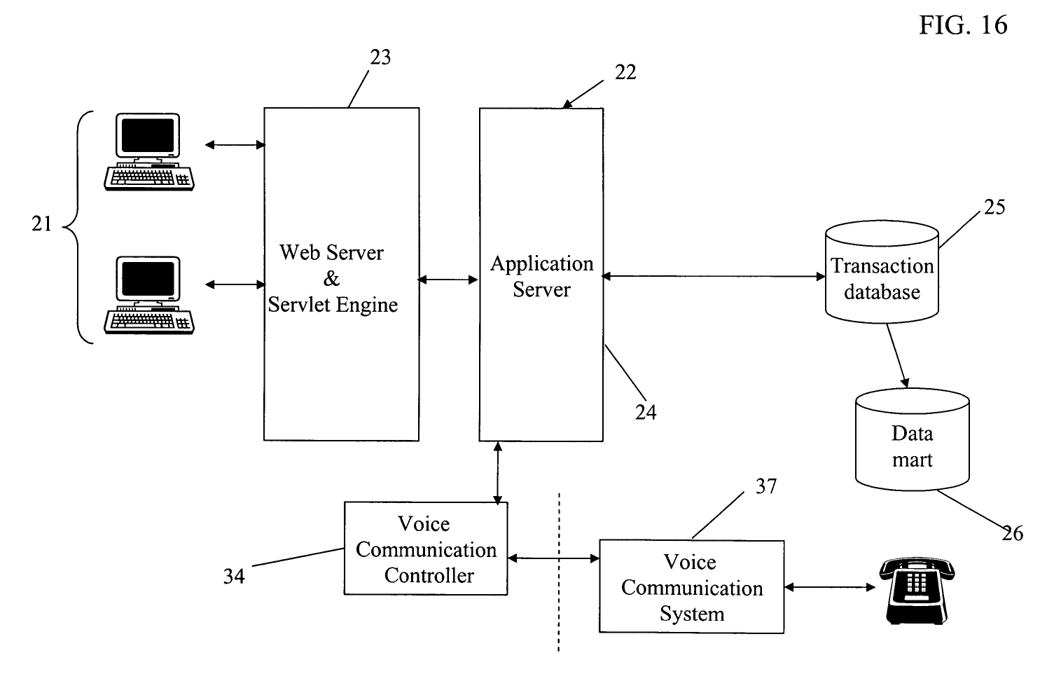

As shown in FIGS. 15 and 16, the present invention can be configured to handle voice communication services as well as data. For example, a user moving from his or her default workspace to workspace in the same or another facility will find it most convenient if their voice services are transferred to the local device at the facility where they will be located. In this way, their voice profile, telephony functions such as voice mail and other customized phone attributes can be transferred and bound to their new location for the duration of their visit. In one embodiment, as shown in FIG. 15, the user makes a reservation through a system interface 32, which collects their voice communication profile information from the database 33 using application engine 32A, and notifies the voice communication controller 34. The voice communication controller can comprise a switchboard, operator and/or agent 34A, control and data files 35 and a voice communication control driver 36. The voice communication controller 34 passes control and data files 35 to the voice communication control driver 36 for binding or removing the user profile to or from the physical device 38 where the user will be located, via the voice communication system 37.

In the present invention, the switchboard, operator and/or agent 34A along with the control and data files 35 transport appropriate data between the system database and the voice communication control driver 36. The driver 36 continuously loops through the process of checking for a voice communication controller termination flag, which signals a request from the voice communication controller for the driver application to terminate. Within this loop, another loop can execute to check for the voice communication controller start flag, which signifies that there is task data in the task file containing commands. When the driver 36 detects a start flag, the interface will transmit user and device information, as well as commands that instruct the call manager to log a specific user into or out of a specific device. When signaled by the driver, the interface will pass a completion flag with success or failure codes and, if applicable, error codes and specific messages from the call manager back to the voice communication controller 34. Data transmission between the voice communication controller and the driver can be performed using a task file API (application programming interface). Control flow between the voice communication controller and the driver can be negotiated using a signal file API.

Upon receipt of a login or logout command from the driver 36, the voice communication system interface can translate the task data from the task API into XML that conforms to the login service document type definition (DTD) supplied by the voice communication system (e.g., Cisco™ Call Manager™). The voice communication system interface can be made specific to the login request and login response DTDs for the current login service version. In one embodiment, the driver 36 sends the resulting XML to the login service active server page (ASP) via HTTP POST, and the interface then waits for the response from the voice communication system. Upon receipt of a login/logout response from the login service, the driver can translate the XML data into voice communication controller task data, which can then be passed from the voice communication system interface to the driver 36 for flow control and error handling. All transmissions to and from the voice communication system interface to the voice communication system can include authentication data for the driver itself 36, as well as the user and device data required for the given situation. Further, the voice communication system interface need not use the login service query functionality provided by the commercial manufacturer of the voice communication system.

The provisions in the system of the present invention for interacting with the voice communication system ensure a cohesive solution for businesses. For example, the system of the present invention can be used to initiate and terminate voice communication profile transfer to a given phone extension for a given workspace in several different ways. In one example, the user can specify when the system should transfer his or her voice communication profile. In another example, the system of the present invention can enable the transfer to occur automatically at a certain time each day. In one embodiment of the invention, the system will be given a “sweep time” in which to “sweep” all temporarily transferred voice communication profiles from the given extensions. In a further example, the system can establish a start time and a complete time for the user's reservation and automatically transfer the user's voice communication profile at the start and complete times. In still a further example, the system can establish a buffer time period, which gives the user time to “check in” to his or her reservation past the reserved start time. If the user checks in prior to the expiration of the buffer time period, the system would then leave the voice communication profile at the reserved extension; otherwise, the system could terminate the profile from the given extension. In another example, the system of the present invention can delay the transfer of the voice communication profile from a given extension automatically at the end of the last day of a multiple day reservation. In another example, the system of the present invention can transfer the voice communication profile from a given extension automatically when the user employs the Check Out command.

Integration with Other Services

In one embodiment of the invention, the system can be integrated with third party packages. For example, the system can be integrated with e-mail and ICS (Internet Calendaring Standards) supported applications, such as Lotus Notes™ commercially available from IBM Corporation and Exchange™ from Microsoft Corporation. The present invention can further be integrated with HR System programs, such as Peoplesoft™, commercially available from Peoplesoft, Inc. The present invention can utilize standard XML and ODBC technologies and therefore is capable of integrating with space recharge systems, visitor management systems, security systems, and finance systems, catering, facility management, air/car/hotel, video services such as video collaboration and video conferencing, as well as leading telephony switches such as those commercially offered by Cisco Systems, Avaya, Nortel, Siemens, Comdial, Bosch, Lexicom and others.

Actual Use of Space

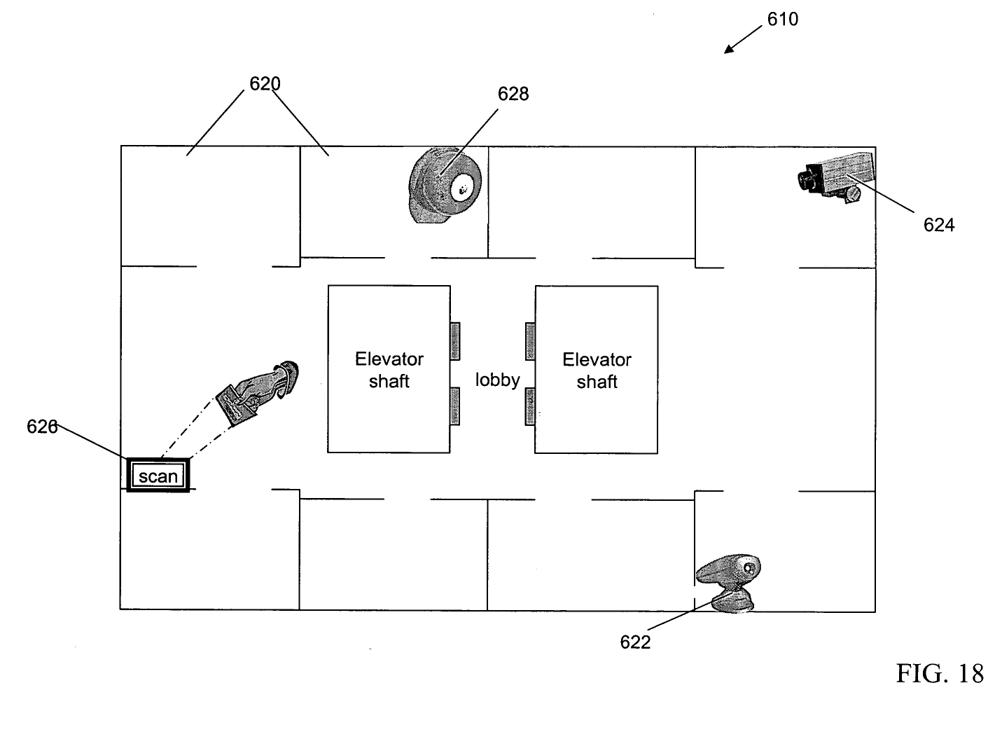

As shown in FIG. 18, there is provided a schematic overhead view of a single floor plan 600 such as might be in place for an office building employing the present invention. There are eight rooms (see reference numeral 620) in this example diagram, and various types of sensors are provided in accordance with one aspect of the present invention. For example, a motion sensor 622 is provided to detect motion in the room. A video camera 624 is provided to detect the existence and identity of anyone in the room shown. A security scanner 626 is shown to identify and determine who is or may be using a security card to gain access to the work floor and/or a specific office. The security card or another appropriate article held by the individual can include a radio frequency identification (RFID) tag. It will be appreciated that the security card and/or embedded RFID card can be scanned by an appropriate scanner based on the technology employed in order to allow access and account for the user's presence on the floor and/or office involved. Another room is provided with a carbon dioxide sensor at 628 to determine the presence of a human by the amount and concentration of carbon dioxide from the person breathing. Detectors known in the art can be employed in accordance with one embodiment of the present invention.

It will be appreciated that more than one of the above sensors can be positioned inside or outside a particular office in order to improve accuracy of the invention. If, for example, one were to place a dog inside an office with a CO₂ sensor, the sensor might obtain readings misinterpreted as the presence of a human being. Further, if one person were to piggy back on another person's card to gain entrance into a floor or office, there would be no indication of the person's presence for the system of the present invention to detect; however, that person would be present in actuality, thereby skewing the results. In addition, different sensor types such as accelerometers can be employed with the above sensor types.

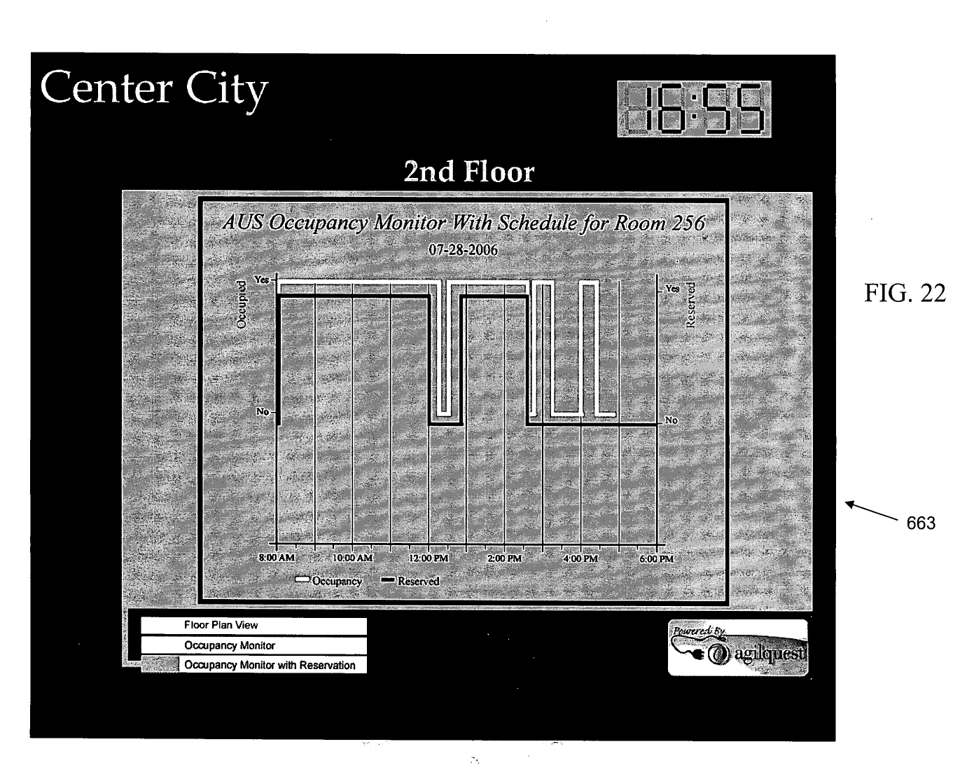

Each sensor provided in the workspace is connected to the system network, which can be any of a variety of hardware, software and communications technology designed to facilitate corporate information processing. In one embodiment, the main server farm can be located on or away from the office location, and can include typical office suite software, internal and external (e.g., Internet) network access capabilities, security, corporate web server, transaction server, e-mail server, as well as an application server for assisting in the execution of the present invention as described above. The information provided by each sensor can be collected, aggregated and presented to a user via a computer interface, such as a visual display. The interface can provide information that helps the present invention track actual use of real estate. FIG. 22 is a sample screen shot 663 of an occupancy monitor interface in accordance with one aspect of the present invention.

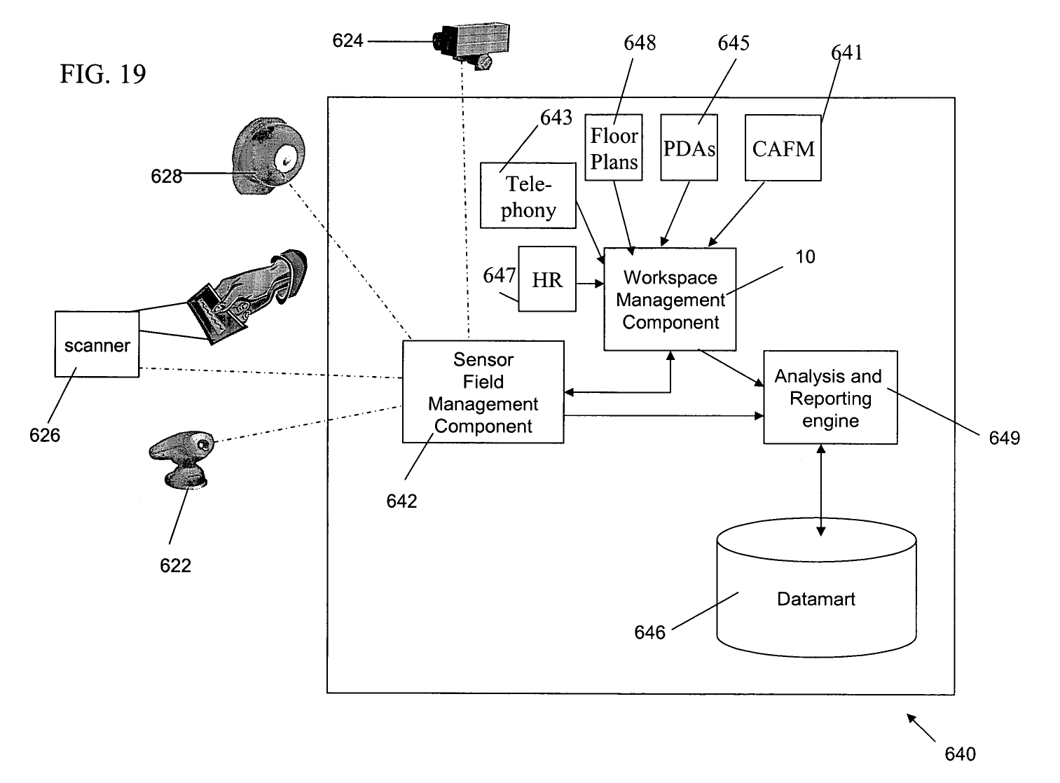

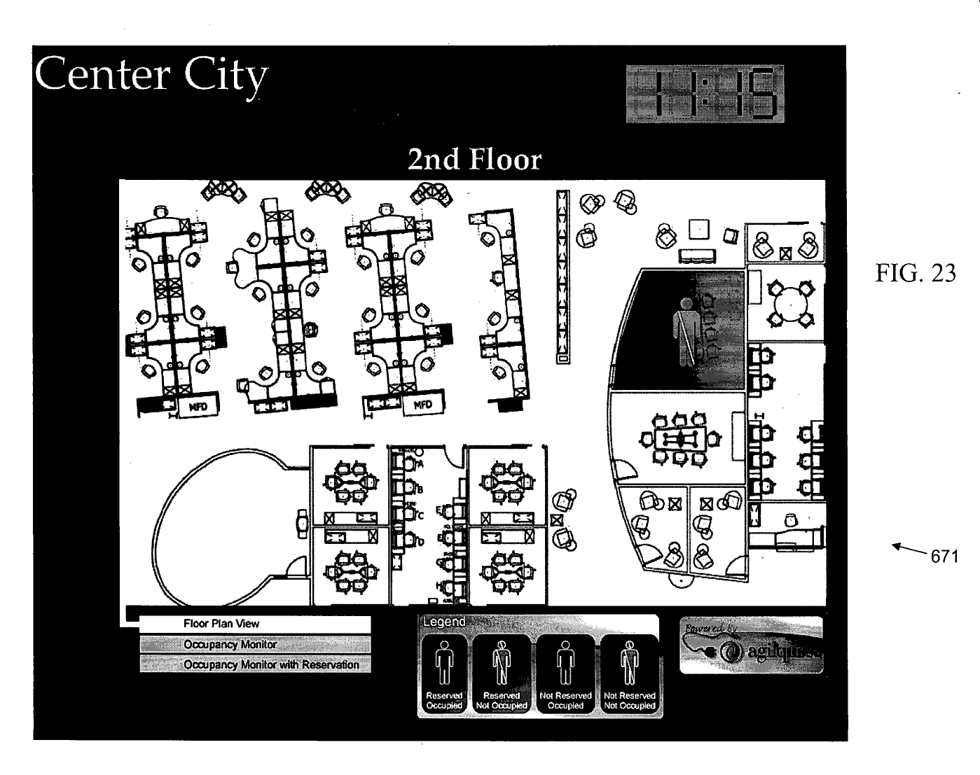

FIG. 19 illustrates a sample schematic representation of a system 640 of one embodiment of the present invention showing the interaction of a sensor field management component 642 with workspace management component 10 and datamart 646. The sensor field management component 642 captures and manages the information obtained from the various sensors 622, 624, 626 and 628. By communicating with workspace management component 10, sensor field management component helps the system of the present invention identify who is in the building, when they were there, and where they most likely are located. This arrangement also helps the present invention to know the location of unoccupied workspaces in all facilities. The present invention can provide this information in real-time or near real time so that operations of the building can use the intelligence being gathered to find available workspaces and use them. FIG. 23 is a sample interface 671 showing floor plan occupancy in accordance with one aspect of the present invention.

With the sensor information integrated into a workplace management component (WMC) that provides the operational management of the workspaces (e.g., move management, conference room scheduling, hoteling management), the present invention can accurately assess who and how many people are using what space, when, where and for how long, all substantially in real-time. In one embodiment of the present invention as shown in FIG. 19, the presence data from the sensors (e.g., security systems, motion detectors, RFID recognition, etc., at 622-628) can be combined with telephone activation recognition data 643, bed checks recorded with wireless PDA's 645, for example, people data from a human resources (HR) program/database 647, floor plan information 648, inventory data from the facilities management (CAFM) program/database 641 and check-in/check-out and other reservation system data as from WMC 10 in order to provide the most accurate actual use data for use with the present invention. In one embodiment of the present invention, the data are collected by WMC 10 as part of its routine workplace management functions, stored in datamart 646 and delivered to engine 649. This combination of data inputs is part of the “gather” element of the present invention.

The present invention takes the gathered data and structures it in various ways in the datamart 646, to enable analysis and the production of business intelligence about real estate use. The present invention can further combine the data with other meaningful data elements such as financial, human resource, and other data to create charts, graphs, lists and other reports designed to produce the metrics desired. Visual representations such as “dashboard-type” graphical user interfaces can provide the user with a visual, optionally interactive, representation of the actual use data. The present invention can further compare the business intelligence generated through this process with the current budgets and plans in place, and determine the variances. The measurements and analysis provided by the present invention support further actions based on these variances to reduce/increase the amount of office space available, reconfigure office space, consolidate operations, use it for business continuity planning and resiliency purposes, for example. In addition to space configuration planning, space needs evaluations and growth accommodation planning, the present invention can assist in evaluating an individual's particular “mobility quotient.” The mobility quotient results from the system of the present invention learning more and more about an individual's actual use of space, and impacts items such as HR policies, communications policies and the individual particular working “toolset.” For example, if an individual is known to travel frequently and have a high mobility quotient, the individual may need more access to more resources at several locations, thereby requiring a larger, more robust toolset. Such an individual may also require a communications policy that plans for long distance calling costs (e.g., the individual can be part of a corporate telecommunications services package that reduces fees for frequent long distance calling).

Analysis and reporting engine 649 is provided for the above purposes, and an appropriate user interface (not shown) from a computing device (e.g., desktop computer, laptop, wireless communication device) can be used to view the interface and access the analysis and reporting engine 649 in order to access and use the above features of the present invention. In one embodiment, analysis and reporting engine 649 comprises an actual use of space (AUS) component to measure the actual use of space as informed by one or more sensors, with or without input from the HR, WMC, CAFM or other elements described above.

In another embodiment of the present invention, the AUS component can communicate with a utility control switch (not shown) such that, if an assessment indicates that a pre-determined threshold of some variable measurement is met or exceeded, for example, the utility control switch can effect a change among one or more supporting utilities associated with the business real estate. For example, if the heating/ventilation/air conditioning (HVAC) system of the commercial real estate is programmed to lower temperatures when more than fifty people are occupying a certain portion of the space at the same time (because people generate heat), then the AUS component can be employed to notify the utility control switch to lower temperatures upon gathering the actual use data indicating that more than fifty people are occupying a given space. Other utility components capable of receiving instructions can include, without limitation, the power system (main and/or backup), water system, fire emergency notification system, police emergency notification system, power windows and door system, access control system, security system, and any other system associated with a business real estate property that can be automatically controlled.

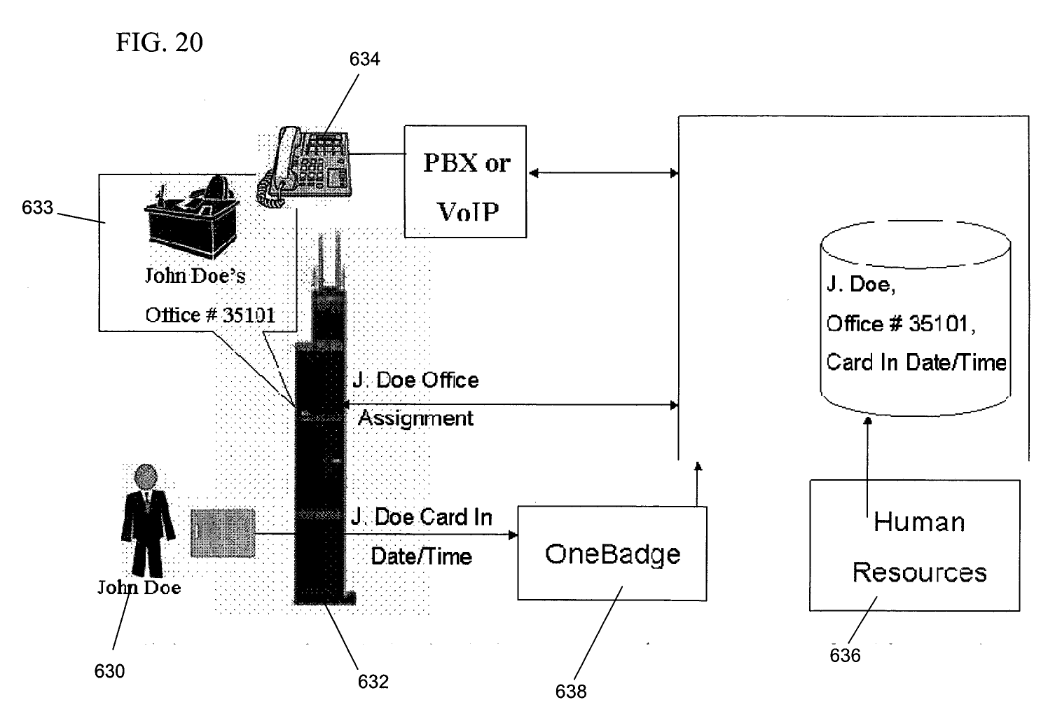

FIG. 20 shows an example implementation of one embodiment of the present invention. As shown therein, employee John Doe 630 badges into Sears Tower 632. J. Doe has a desk assignment in the integrated workplace management system (WMC) for office 35101 as indicated at 633. WMC integrates with the telephony system 634 for at least two strategic reasons: (1) it ensures the assignment of John Doe to Room 35101 is accurate, and (2) it ensures that hotelers book the space they need for an accurate representation of use (e.g., make booking, get phone; no booking, no phone). The WMC further integrates with human resources component (HR) 636 to maintain an accurate accounting of the people housed in the building. The WMC further can integrate with a security system 638 such as OneBadge™ that can provide access to turnstiles, building entry and various internal doors securing public access from company only (private) space, and uses this information to serve as a “presence event” that the employee came to work that day and used his assigned desk. For the purposes of the present invention, an assumption is made that an employee who enters the building uses his or her assigned space. If needed, there are mechanisms that can be turned on to make this assumption even more accurate.

Using the sensors and sensor field management component, the present invention measures the actual use of space using various forms of technology sensors such as described above to gather data about human presence in the office space. This information can then be quantified and/or measured using business intelligence methods in accordance with the present invention to allow organizations to empirically compare the actual use of facilities to their planned use, ultimately allowing the given organization to take different actions based on this information to produce organizational value. For example, in connection with the scenario described above with FIG. 20, the present invention can, upon sensing that John Doe will be appearing in office 35101, the present invention can locate one or more sensors in and/or around the office 35101 to begin measuring actual use of space. Locating can mean the physical placement by personnel of one or more sensors in the office, the hallway or the reception area for that floor (if available) to sense John Doe's physical presence when he arrives. Locating can also mean initiating a communication function from the AUS component to a sensor management component to determine that a previously positioned sensor is activated and/or functioning properly, for example. Once John Doe is acknowledged or sensed by the system of the present invention as being perceptible by one or more of the sensors (e.g., through a security badge identification pickup, a visual camera, a telephone pickup, a computer logon, etc.), the present invention can activate the one or more located sensors to provide feedback to the sensor management component and thereafter the AUS component. Alternatively, the present invention can activate the one or more located sensors at the appointed date and time of John Doe's reservation through the WMC.

It will be appreciated that one or more of the sensors can be in “always on” mode and continuously recording presence events. It will further be appreciated that the sensors can be set to record and provide feedback only after one or more sensors detect a presence in a given area of the real estate portfolio.

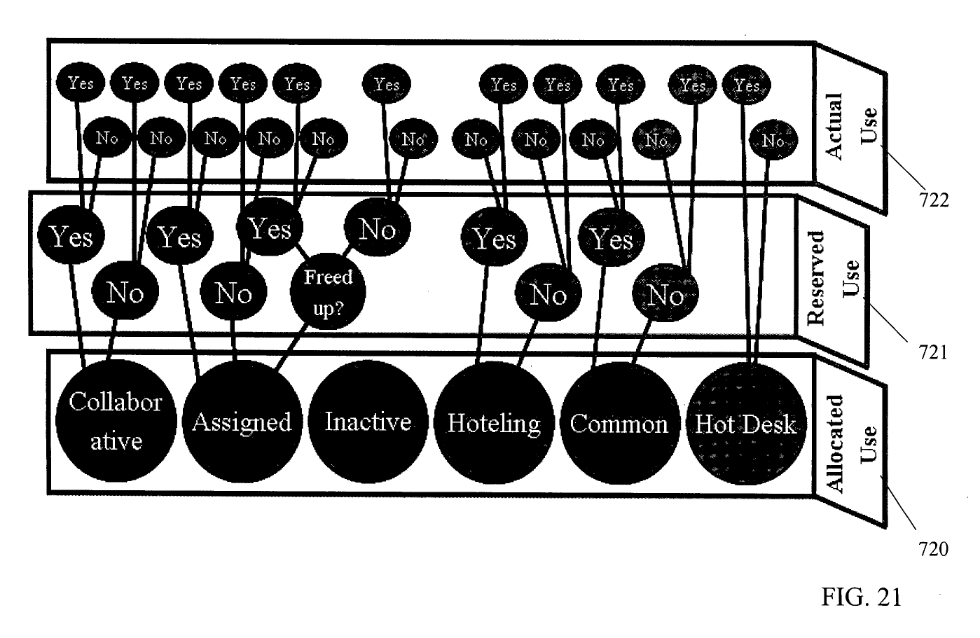

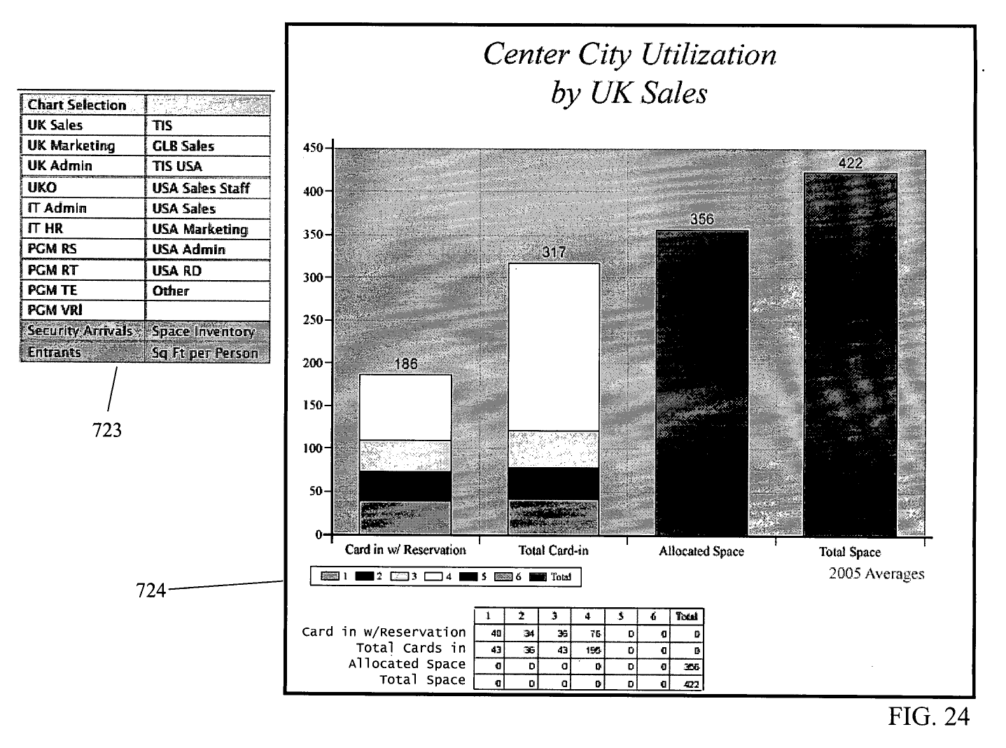

As shown in FIG. 21, the present invention builds on existing computer aided facility management (CAFM) information 720 and adds workspace management information 721 with the AUS measures 722 to produce compelling, actionable business intelligence. As shown in FIG. 24, clickable menu 723 provides access to chart 724 depicting the relationship of CAFM data to actual use of space (AUS) information and Workplace Management information, at a logical business grouping, for example.

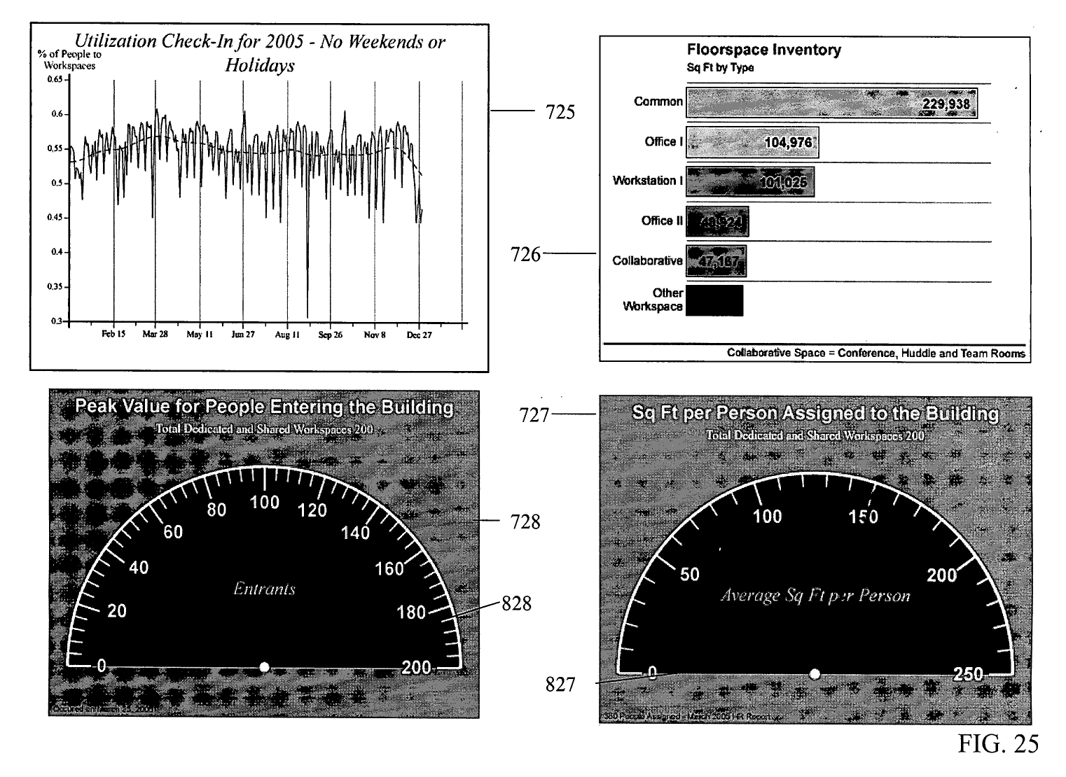

As shown in FIG. 25, a chart depicting the number of people entering the building as a percentage of the available workspaces is shown at 725. This measure is useful for understanding variability over time and available capacity for additional use. Chart 726 depicts the square footage organized by space type. Chart 727 depicts the average square footage per worker assigned to the building. The value of the specially shaded area 827 is gathered from planning and budgeting functions and added to the AUS reporting repository as metadata. This dashboard measure can convey operational efficiency or lack thereof. Chart 728 depicts the peak value of workers entering the building. The value of the specially shaded area 828 is gathered from planning and budgeting functions and added to the AUS reporting repository as metadata. This dashboard measure can convey how close to full the facility has been during the period of measure.

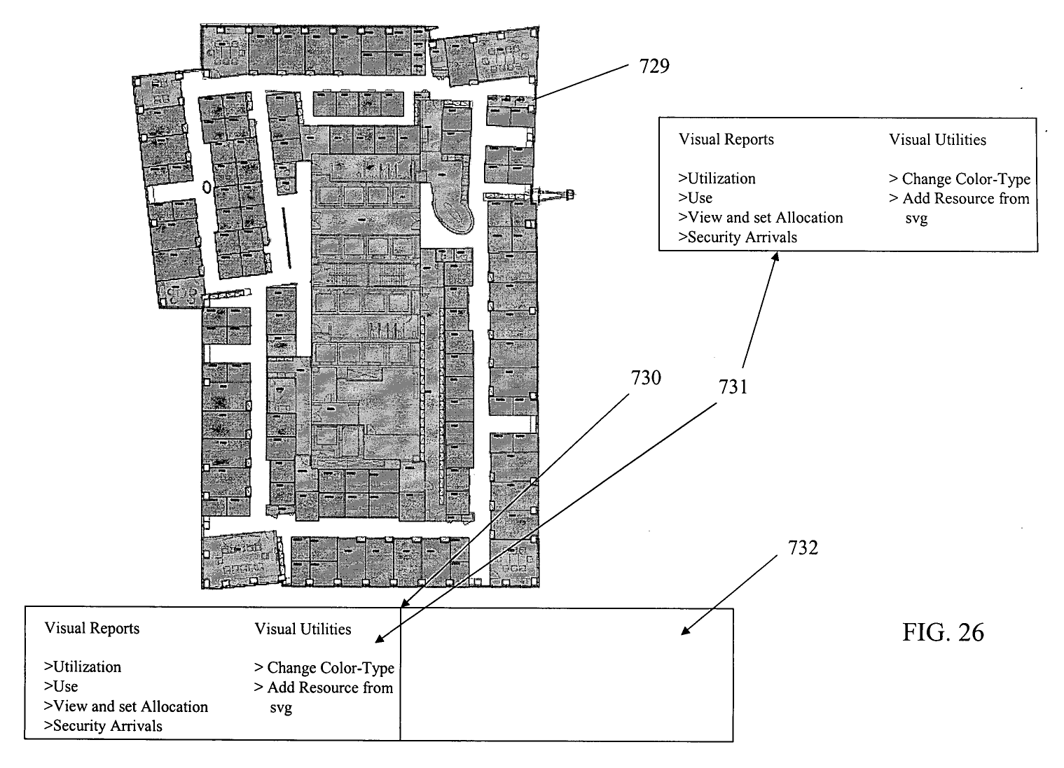

As shown in FIG. 26, floor plan 729 has spaces set to a neutral color to signify their location but nothing more. Element 730 is the menu and control area, element 731 is the menu allowing access to the various visuals and tools, and element 732 is a secondary window for display of information and calendaring.

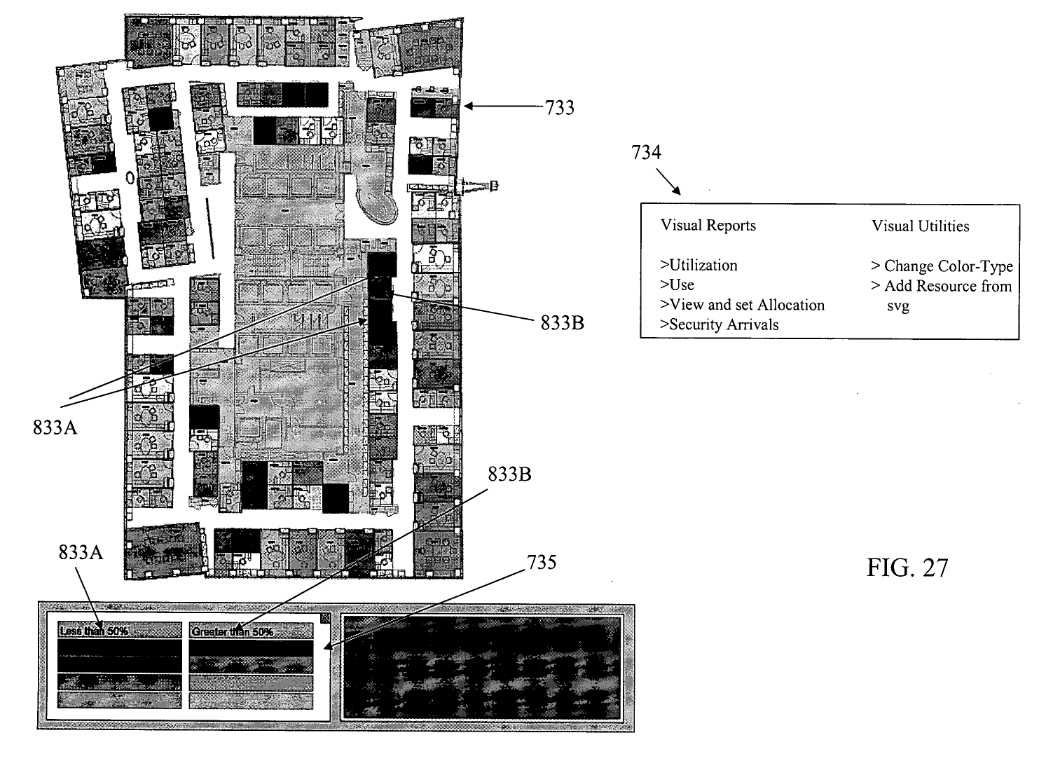

As shown in FIG. 27, floor plan 733 depicts the percent utilization using various shades 833A, 833B (or optionally colors) and varying opacities to convey percentages at a glance. As depicted on the legend 735, higher opacity shades 833A are used less and higher opacity shades 833B are used more. Main menu is also shown at 734.

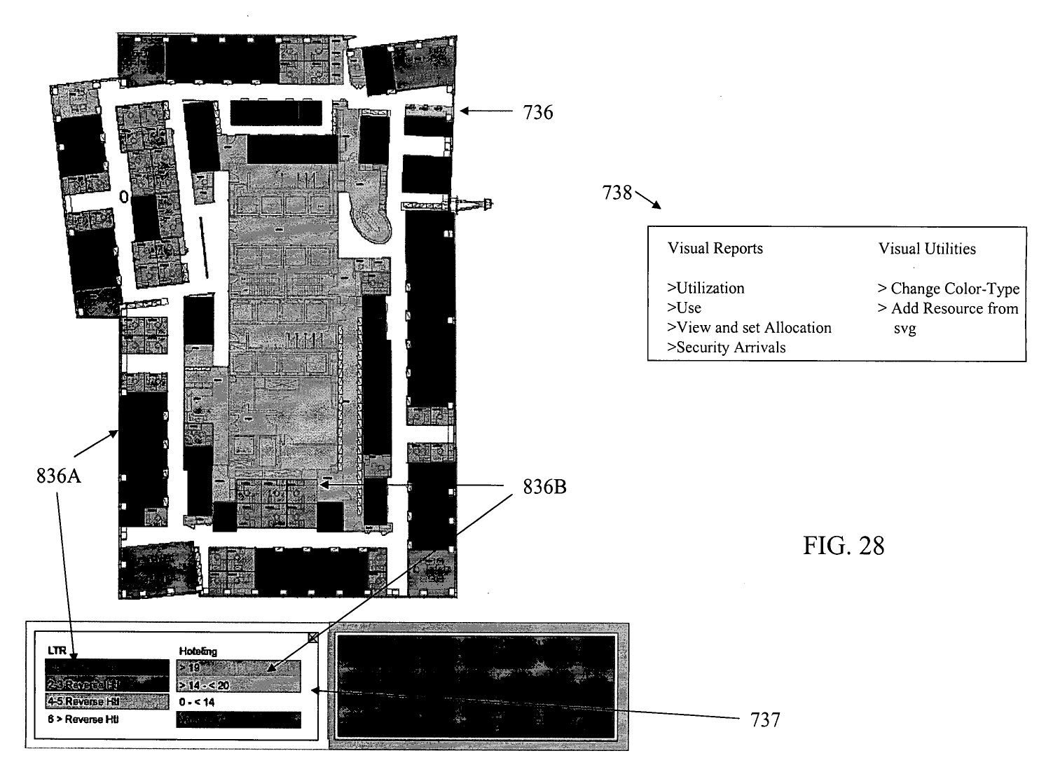

As shown in FIG. 28, floor plan 736 depicts the number of hoteling and reverse hoteling events during the period of measure. As depicted on the legend 737, higher opacity shades 836A are LTR locations used less for reverse hoteling and higher opacity 836B are used more frequently for hoteling. Main menu is also shown at 738.

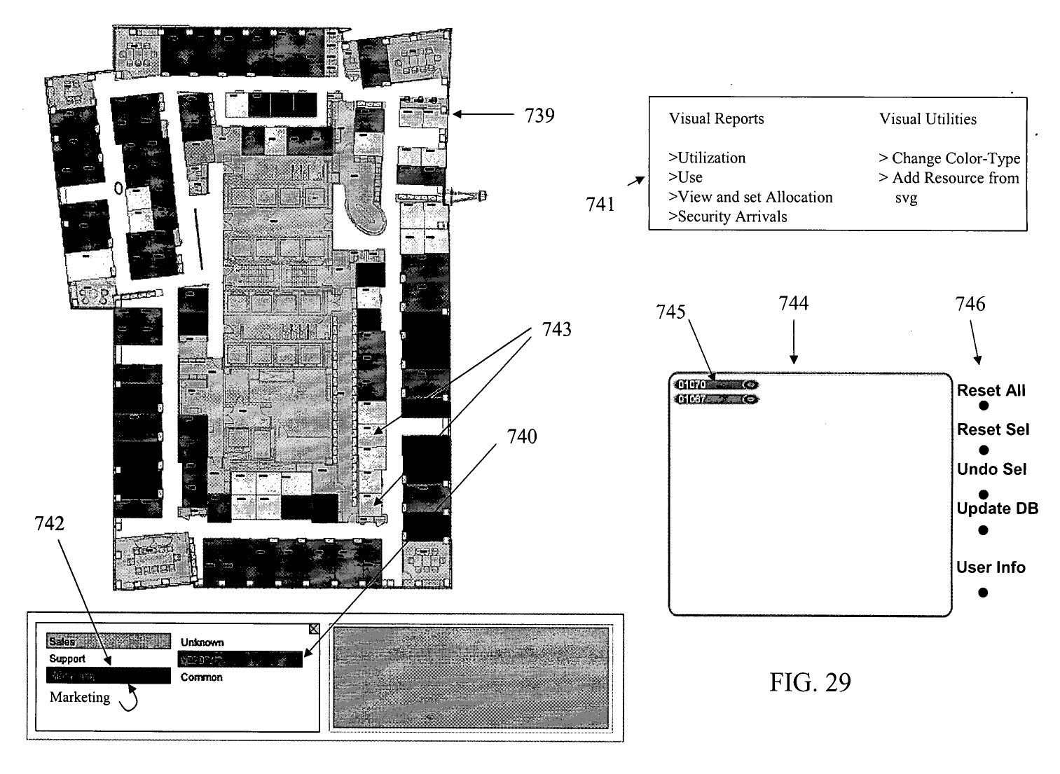

As shown in FIG. 29, floor plan 739 depicts the various departments to which the space has been assigned as shown on the legend 740. Main menu is also shown at 741, and the legend 740 is clickable and when a department has been clicked as at 742, the action of clicking a space(s) 743 on the floorplan 739 will turn the space the color 742 of the department in the legend and put the space 745 into the “set allocation manager” (SAM) control 744. The SAM control 744 has a number of list management and submit changes options 746. Clicking submits the revisions as xml back to the repository server where they update the database.

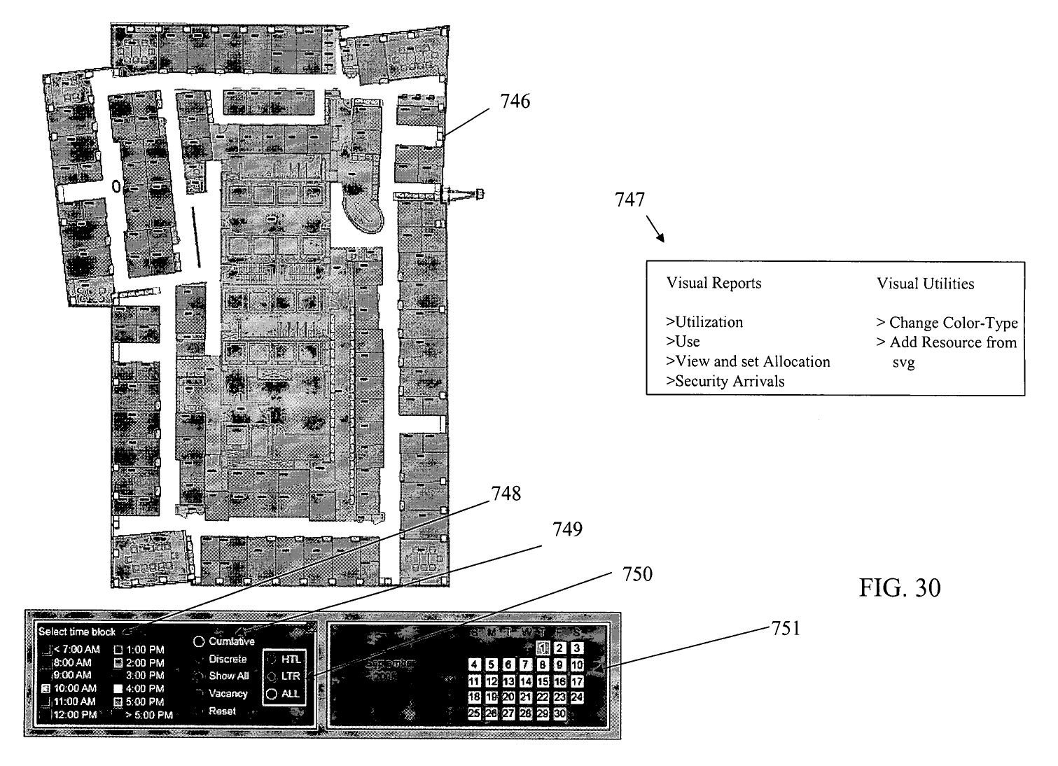

As shown in FIG. 30, floor plan 746 depicts the neutral state. Main menu is shown at 747, and a menu area “Select time blocks” 748 is used to change the color or shading of the space on the floorplan for any spaces whose occupant arrived during the time block for the date selected on the calendar control 751. The “type of reservation” 750 filters the spaces colorized. The show all option 749 will display all timeblocks at once for the current filter settings. If the Cumulative option is selected, any additional time blocks selected will add to the already colorized spaces. If the Discrete option 749 is chosen, then only the current time block selected spaces will be colorized, all other spaces are returned to neutral color. The “Vacancy” option will display vacant (unused for the day) spaces as filtered by date 751 and type of reservation 750. The “Reset” option 749 returns the colorization of spaces back to the neutral color.

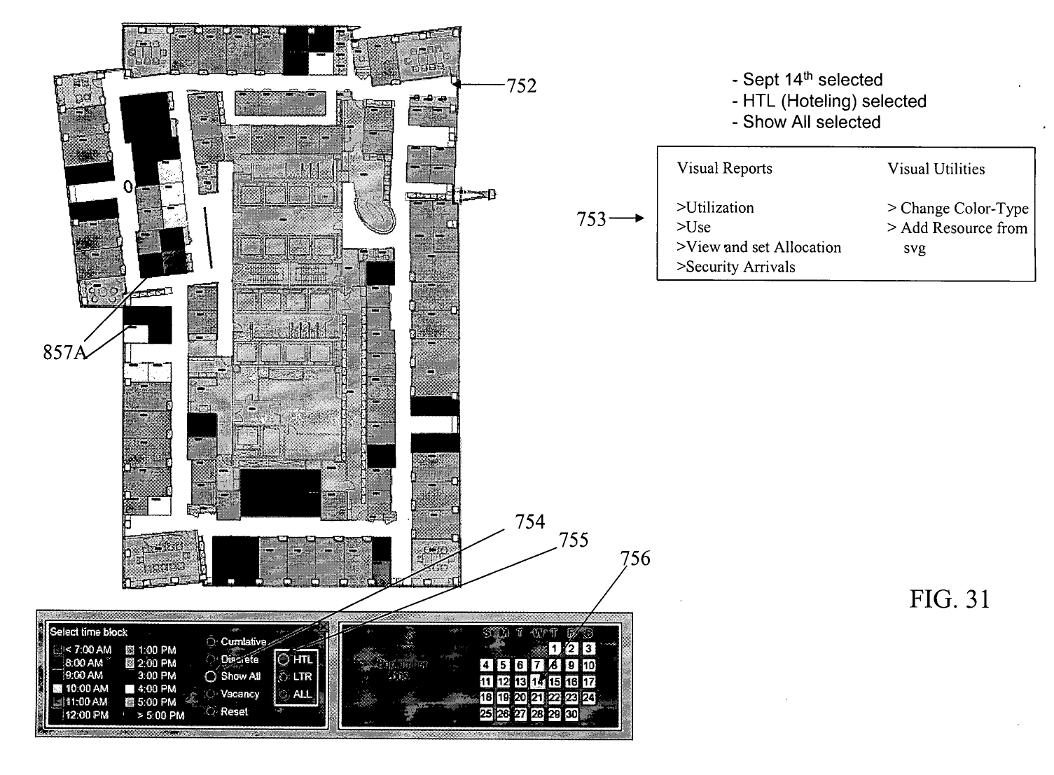

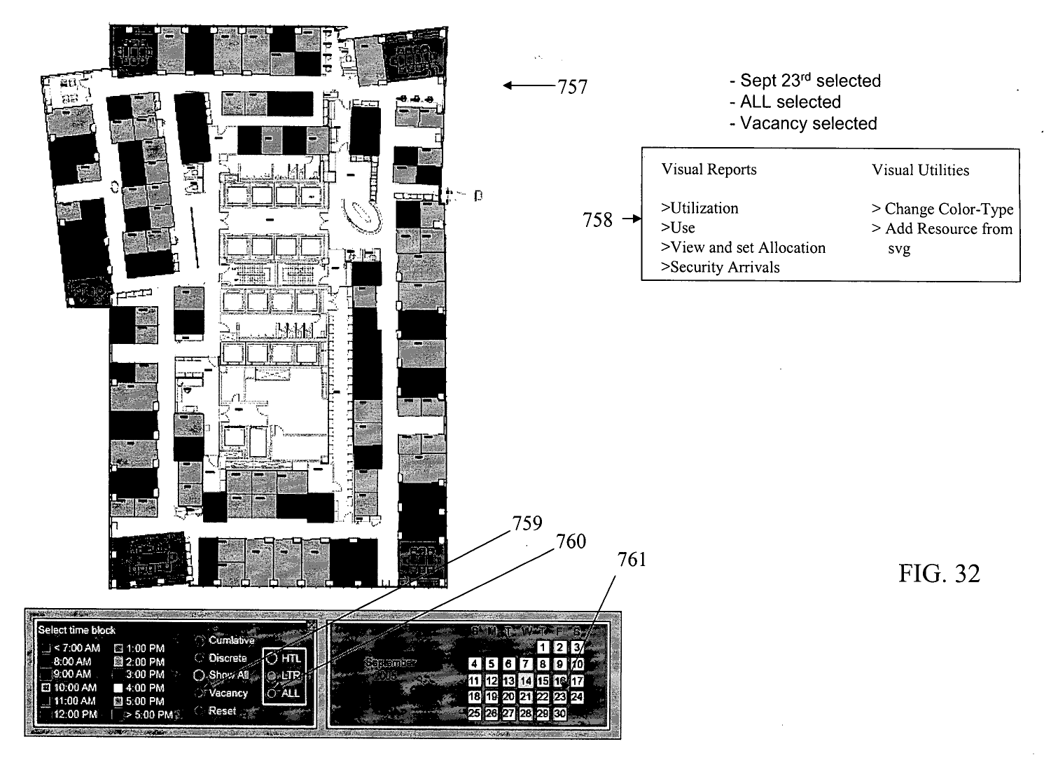

As shown in FIG. 31, the “HTL” filter 755 and “Show All” option 754 are selected. Floor plan 752 depicts the colorization of spaces based on arrival time of occupant as determined by reservation for the space that day. Main menu is also shown at 753, and calendar selection of September 14 is indicated at 756. As shown in FIG. 32, the “ALL” filter 760 and “Vacancy” options 759 are also selected. Floor plan 757 depicts the colorization or shading of spaces as at 857A when unused. The space may have been unreserved or reserved. If the space was reserved the reservation owner did not arrive on the day controlled by the calendar 761. Main menu is also shown at 758 in FIG. 32.

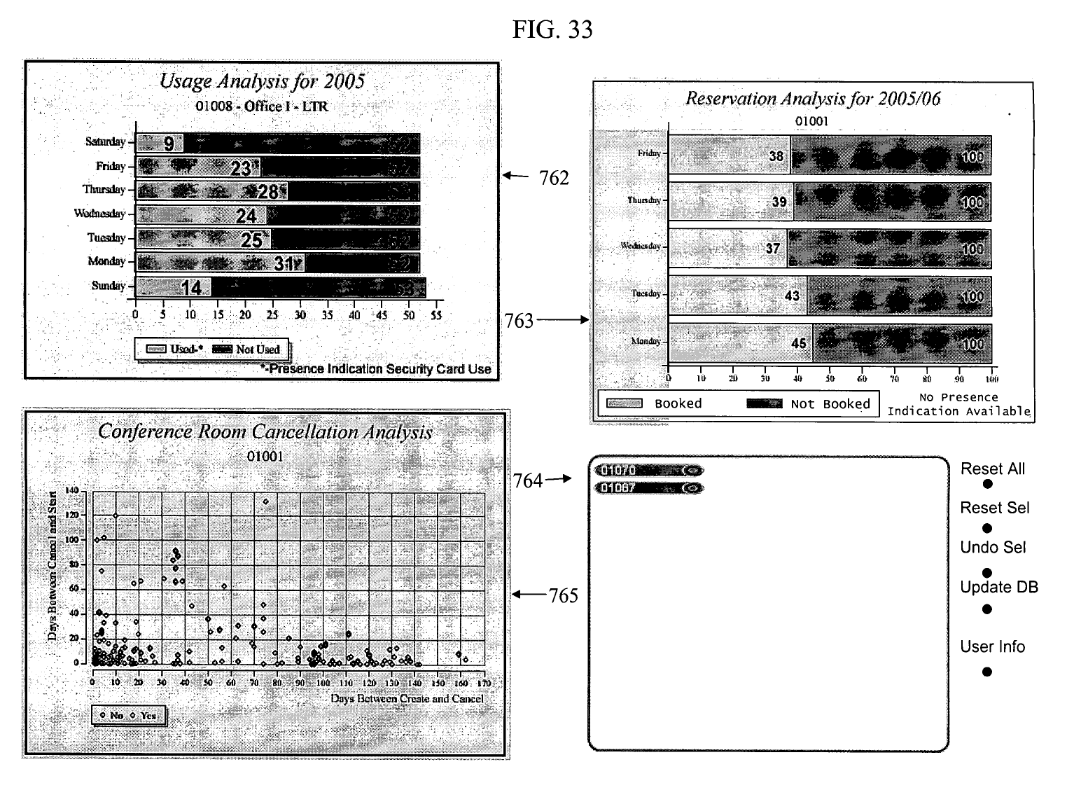

FIG. 33 shows sample charts that can be invoked from the floor plan by clicking the space in accordance with one embodiment of the present invention. In one embodiment, all charts are rendered based on data stored in the repository. As shown in FIG. 33, chart 762 depicts that the space clicked is an LTR or HTL space. In the example shown 762, the space clicked was an LTR space. The bars show by day of week how many times the space was occupied during the 52 weeks being measured. Chart 763 depicts the percentage of time between the hours of 8:00 AM and 6:00 PM that the conference room was reserved on average by day of week during the period of measure. Chart 764 depicts every time a reservation was cancelled and plotted by comparing the length of time from the date cancelled to the start time of the reservation against the length of time from the creation of the reservation to its cancellation date and time. A further depiction of “was the room reserved for the time block cancelled” 765 is meant to convey the impact of having the room locked up for planning purposes until the last minute.

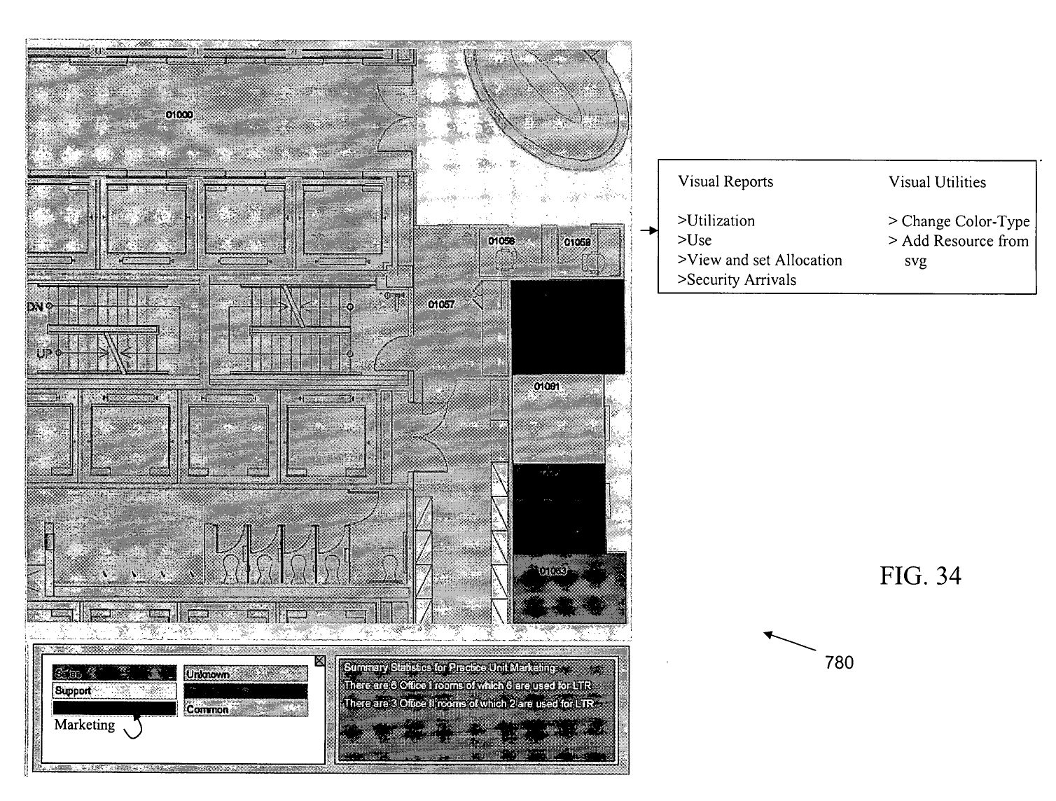

FIG. 34 is an illustration 780 of the “Zoom In” capability of the floorplan in accordance with one embodiment of the present invention.

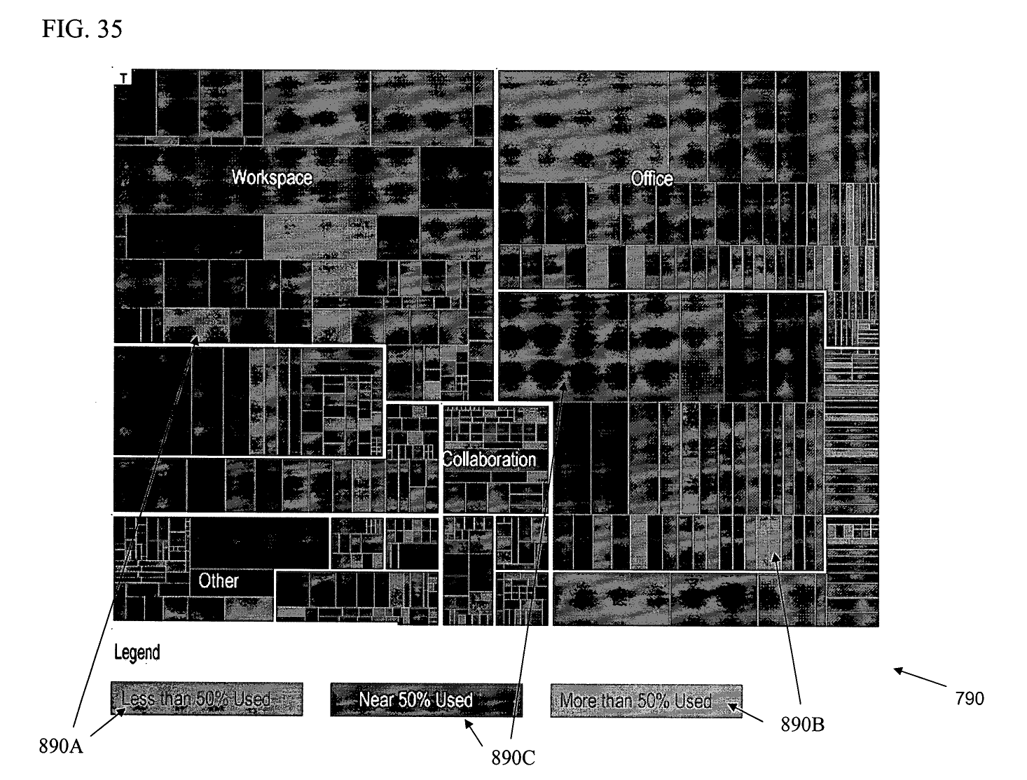

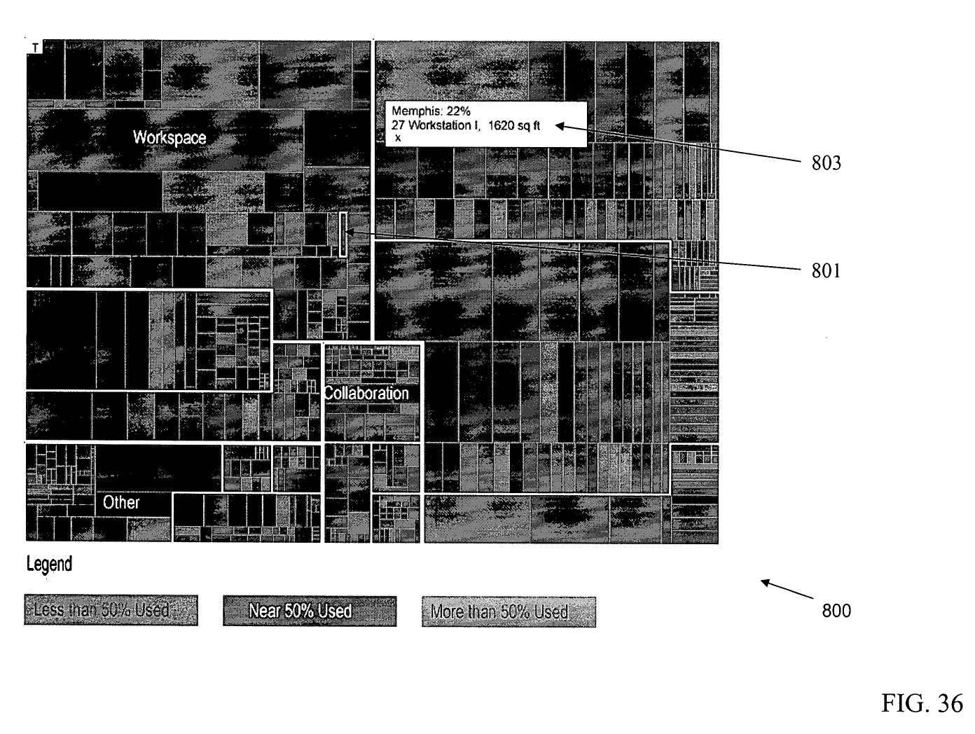

FIG. 35 is a sample interactive chart 790 depicting the utilization of an entire portfolio by space category and type as well as the relative size to the entire portfolio square footage in accordance with one embodiment of the present invention. As shown in FIG. 35, shades 890A with higher opacities are used less and shades 890B with higher opacities are used more. Opacities near zero for shade 890A or shade 890B appear black as at 890C and are used nearly 50% of the time and unused nearly 50% of the time. This powerful view gives a real estate manager an easy way to visualize CAFM and AUS information together and serves as launch point for further analysis. The shading or colorization can be done based on xml data from the repository, for example. FIG. 36 shows an example display 800 of the AUS Portfolio Visualizer showing the “mouse over” 801 highlighting the boundary around the representative space and the popup information 803.

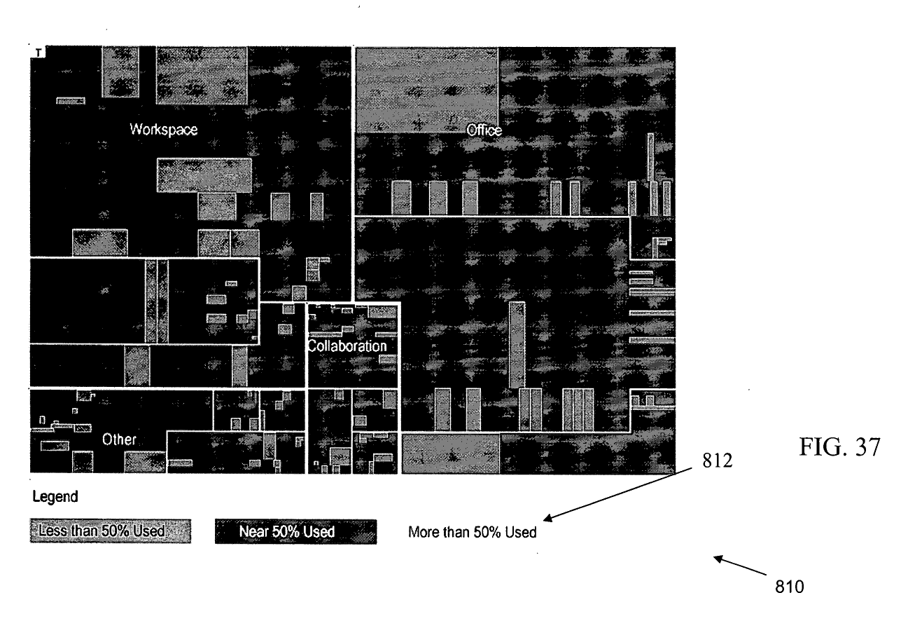

FIG. 37 is an alternative display 810 of the AUS Portfolio Visualizer of the present invention, showing the selection of Option “More that 50% Used” 812. The other elements are hidden allowing a more focused analysis to occur. In one embodiment of the present invention, the system does not go back to the server to get this view to render but simply processes the zml behind the form and renders the new view directly in the browser. The current invention also provides options to view portfolio elements with “Less than 50% Use” and those that are near “50% Use”. The view can be reset by clicking the legend.

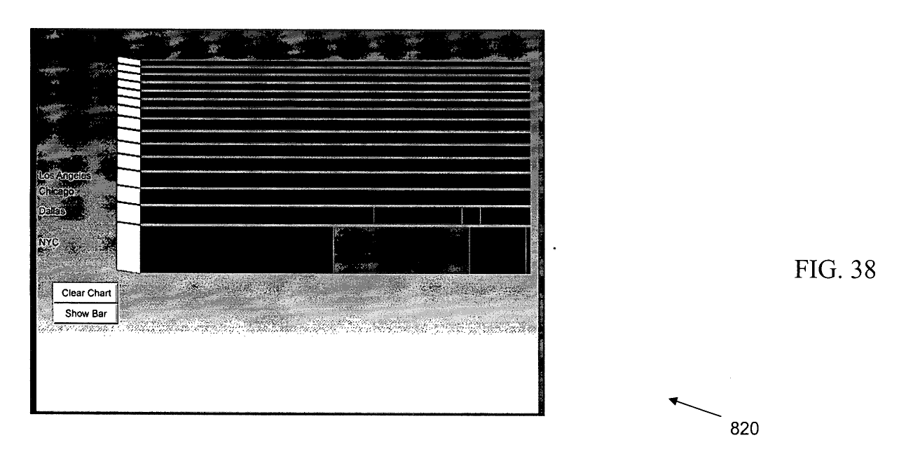

FIG. 38 is a sample interactive chart 820 depicting the utilization of an entire portfolio by facility and space category as well as the relative size to the entire portfolio square footage in accordance with one embodiment of the present invention. This powerful view gives a real estate manager access to charts in addition to at a glance AUS information (AUS Portfolio Visualizer by Facility).

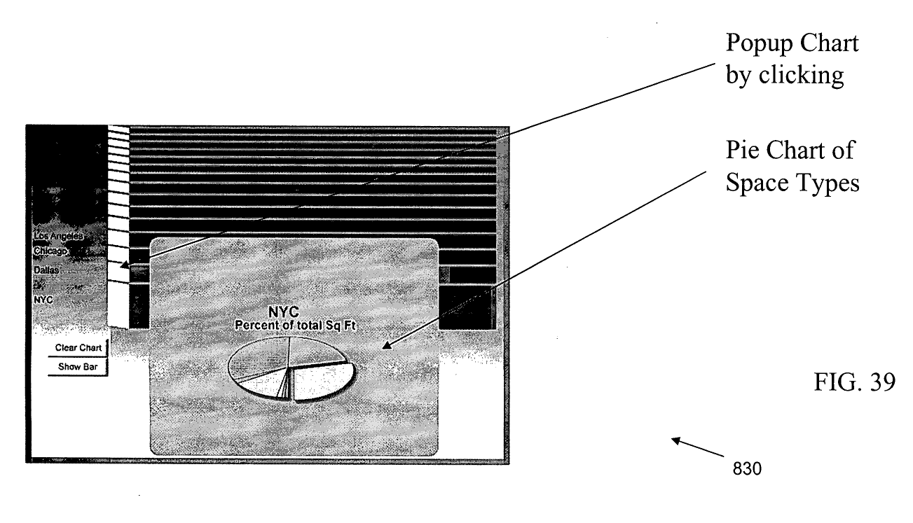

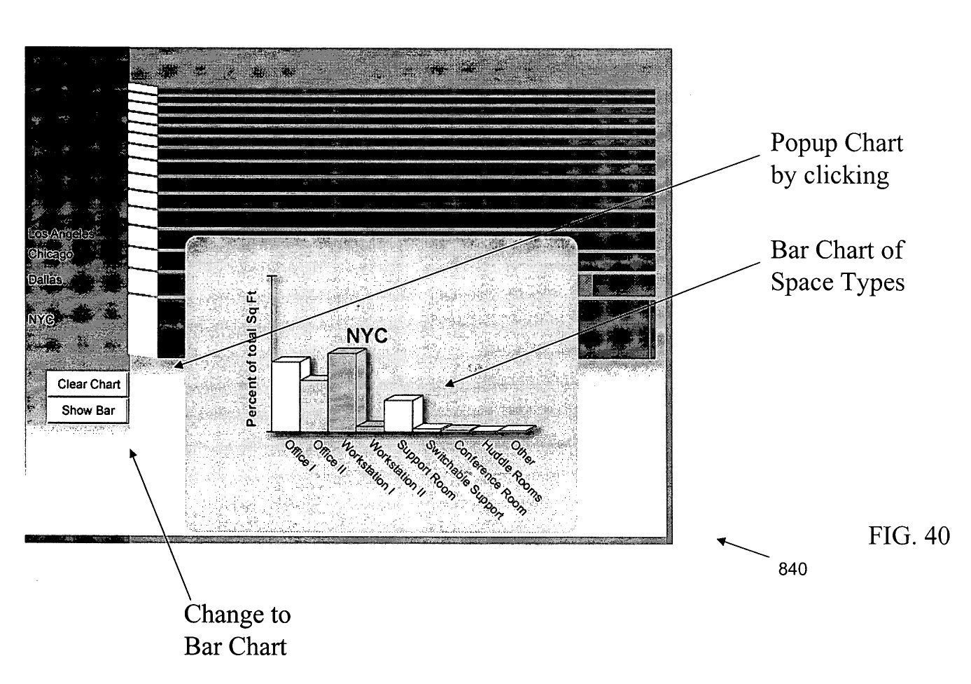

FIG. 39 is a sample depiction 830 of the AUS Portfolio Visualizer by Facility of the present invention, showing the pie chart envoked by clicking the “white hot” area of the facility geometry. The pie chart conveys CAFM space type data. FIG. 40 shows a sample depiction 840 of the AUS Portfolio Visualizer by Facility showing the bar chart envoked by clicking show bar chart button after the pie chart is displayed. The bar chart conveys CAFM space type data.

### EXAMPLES

Below are provided two examples implementing the system of the present invention in operation: the first example is an organization that has an upcoming lease renewal, and the second example is an organization that needs to add more employees to a facility that is fully allocated.

Company A (Too Much Empty Space)

Company A houses 750 people on six floors of a high rise building. The lease on the six floors expires in 18 months. The company is faced with three choices. Should it a) renew the lease on the six floors; b) consolidate onto fewer floors; or, c) move to a new facility?

Within Company A, people have noticed that on a day-to-day basis many desks go unused. Using security-card entry data for the previous twelve-month period, the actual use of space component of the present invention determines that employees can be categorized into three groups: Anchors, Shared, and Mobile. The 50 Anchor people can be assigned using the WMC of the present invention to workspaces that are not shared; the 450 Shared people use their desks more than 50% of the time; and 250 Mobile people use their desks less than 50% of the time.

The actual use analysis component of the present invention shows that the Mobile people actually used their workspaces 30% of the time. Rather than allocate dedicated workspaces to the Mobile workers, the company can designate a pool of shared desks. The actual use analysis component determines that eighty-five desks are needed to satisfy the housing needs of these 250 people. In other words, a one-to-one desk/person ratio is not required and 165 additional desks are therefore not needed. Renewing the lease for five floors would more than suffice, saving the company over $2 million annually.

The actual use analysis component also finds that the Shared people use their desk 75% of the time—meaning that on any given day roughly 110 desks are unused. These desks can be used by the Mobile workers, if needed, or can accommodate an expansion of the workforce.

Company B (Needs to Add Employees)

Company B houses 5,000 employees in a corporate campus environment comprised of six buildings. The campus is full and there is no plan or budget to build more facilities. However, there is a business need to add 500 additional employees to this location. The company needs to know how it can add employees without adding to facilities.

The actual use of space analysis (AUS) component of the present invention compiles six months worth of security entry data showing that the average utilization of all six buildings is 72%. The peak utilization is the same, leading the organization to think initially that it has virtually no mobile workers. However, the AUS component also determines that roughly 650 employees utilize their workspace less than 50% of the time, with average utilization for these people around 23%. Consequently, the AUS component provides an assessment to the company that it needs only 165 desks to house the 650 newly found mobile workers. This frees up nearly 500 desks, which are now available for new employees.

The AUS component determines that the remaining 3,900 employees who use their desk more than 50% of the time actually use their workspaces 80% of the time, meaning that on any given day over 700 workspaces are going unused. The assessment further determines that this organization can easily accommodate the growth of 500 people initially and many hundreds more before reaching full capacity.

In one embodiment of the invention, the system can be integrated with third party packages, in addition to the WMC system described above. For example, the system can be integrated with e-mail and ICS (Internet Calendaring Standards) supported applications, such as Lotus Notes™ commercially available from IBM Corporation and Exchange™ from Microsoft Corporation. The present invention can further be integrated with HR System programs, such as Peoplesoft™, commercially available from Peoplesoft, Inc. The present invention can utilize standard XML and ODBC technologies and therefore is capable of integrating with space recharge systems, visitor management systems, security systems, and finance systems, catering, facility management, air/car/hotel, video services such as video collaboration and video conferencing, as well as leading telephony switches such as those commercially offered by Cisco Systems, Avaya, Nortel, Siemens, Comdial, Bosch, Lexicom and others.

It will be apparent to one skilled in the art that any computer system that includes suitable programming means for operating in accordance with the disclosed methods also falls well within the scope of the present invention. Suitable programming means include any means for directing a computer system to execute the steps of the system and method of the invention, including for example, systems comprised of processing units and arithmetic-logic circuits coupled to computer memory, which systems have the capability of storing in computer memory, which computer memory includes electronic circuits configured to store data and program instructions, programmed steps of the method of the invention for execution by a processing unit. The invention also may be embodied in a computer program product, such as a diskette or other recording medium, for use with any suitable data processing system. The present invention can further run on a variety of platforms, including Microsoft Windows™ or Microsoft XP™ platforms that support Microsoft Internet Explorer™ browser, for example. Linux™, Sun Solaris™, HP/UX™, IBM AIX™ and Java compliant platforms may also be employed by the present invention to the extent compatible. In one embodiment of the present invention, the system backend relies on Microsoft Internet Information Server (IIS)™ and Microsoft SQL™ database management system operating on a Microsoft Windows™ platform.

Further, while the above description illustrates embodiments of the present invention pertaining to conventional office space environments, it will be appreciated that the present invention is not to be limited to such fields. For example, the present invention can be employed in multiple commercial settings, including manufacturing settings, distribution settings, warehousing, parking lots and other business real estate environments.

The invention may be embodied in other specific forms without departing from the spirit or essential characteristics thereof. The present embodiments are therefore to be considered in all respects as illustrative and not restrictive, the scope of the invention being indicated by the claims of the application rather than by the foregoing description, and all changes which come within the meaning and range of equivalency of the claims are therefore intended to be embraced therein.

What is claimed and desired to be secured by Letters Patent is:

1. A computer-assisted system for measuring actual real estate space usage, comprising:
a sensor field management component for coordinating data received from one or more sensors placed within one or more locations of a business real estate property;
a workspace management component in communication with the sensor field management component for providing information pertaining to at least one individual and the at least one individual's scheduled location within the business real estate property for a given time;
a datamart for storing individual information and sensor information as obtained from the sensor field management component and workspace management component; and
an actual use of space analysis component for retrieving the stored data and providing a commercial real estate assessment.

2. The system of claim 1 wherein the assessment provides one or more of: informing a real estate portfolio planning process; informing the reconfiguration of business real estate property; inform a business continuity decision; determining the identity, time and location of at least one individual in the business real estate property; determining the location of one or more unoccupied workspaces in all facilities.

3. The system of claim 1 further including a utility control switch in communication with the computer program, whereupon if the assessment reaches a pre-determined threshold, the computer program can inform the utility control switch to effect a change among one or more supporting utilities associated with the real estate.

4. The system of claim 3 wherein the utility is one of: power; water; fire emergency notification system; police emergency notification system; air system; heating/cooling system; security system.

5. The system of claim 1 wherein the workspace management component communicates with a telephony system, human resources system, bed-check communications component, or computer-assisted facilities management component.

6. The system of claim 1 wherein the sensor field management component receives data from a scanner.

7. The system of claim 1 wherein the business real estate property includes at least one structure in two or more different geographical locations.

8. The system of claim 1 wherein the WMC is accessible by at least one mobile worker, at least one concierge and at least one facility manager.

9. A computer-assisted method for measuring actual real estate space usage, comprising the steps of:
providing a workspace management component (WMC) for facilitating reservation of corporate real estate within a corporate real estate portfolio;
providing one or more activateable sensors within one or more areas of the corporate real estate portfolio;
providing an actual use of space analysis (AUS) component in communication with the one or more sensors;
receiving, via the WMC, an indication that one or more individuals will be appearing and placed in a specified resource location of the corporate real estate portfolio on a particular date within a particular time range;
locating one or more sensors within the specified resource location; and
on the appointed date and at the beginning of the time range, activating the one or more sensors to provide feedback to the AUS component.

10. The method of claim 9 wherein the step of locating one or more sensors includes physically placing the one or more sensors within the specified resource location.

11. The method of claim 9 wherein the step of locating one or more sensors includes initiating a communication function for a previously positioned sensor to determine that the positioned sensor is activated and functioning properly.

12. The method of claim 9 including the step of providing a telephony system in communication with the WMC, wherein the telephony system allows for reservation of telephony equipment associated with corporate real estate in the portfolio.

13. The method of claim 9 including the step of providing a security access control system in communication with the WMC.

14. The method of claim 9 further including the steps of receiving a request for access to a portion of the real estate within the portfolio on a real-time basis from at least one individual on-site at the location of the requested real estate portion, and conducting a real-time search for any available real estate related to the requested portion.

15. The method of claim 9 including the step of determining the identity of an individual or individuals actually appearing in the resource location.

16. The method of claim 9 including the step of compiling one of: a space configuration plan; a space needs evaluation; a growth accommodation plan; an individual mobility quotient.

17. A computer-assisted method for measuring actual real estate space usage, comprising the steps of:
providing a workspace management component (WMC) having an inventory of corporate real estate within a corporate real estate portfolio;
providing one or more activatable sensors within areas of the corporate real estate portfolio;
providing an actual use of space analysis (AUS) component in communication with the one or more sensors;
sensing the presence of at least one individual via one or more of the sensors; and
instructing at least one of the sensors to provide feedback to the AUS component.

18. The method of claim 17 wherein one or more sensors are always on and recording presence events.

19. The method of claim 17 wherein recording and feedback begins once one or more sensors detect a presence in an area of the corporate real estate portfolio.

20. The method of claim 17 wherein the one or more sensors include one or more of the following: video camera, motion detector, accelerometer, infrared detector, telephone system, security system, security card, CO2 sensor.
